(19) United States
(12) Patent Application Publication
(10) Pub. No.: US 2025/0362554 A1
(43) Pub. Date: Nov. 27, 2025

(54) Long-range optical device

(71) Applicant: STEINER-OPTIK GmbH, Bayreuth (DE)

(72) Inventors: Oliver Jäschke, Bayreuth (DE); David Amschler, Bayreuth (DE); Robert Polster, Bayreuth (DE)

(21) Appl. No.: 18/867,893

(22) PCT Filed: Feb. 14, 2023
(86) PCT No.: PCT/EP2023/053623

§ 371 Date: Nov. 21, 2024

(30) Foreign Application Priority Data
May 24, 2022 (DE) 10 2022 113 131.9

(51) Int. Cl. G02F 1/153; G02B 13/16

(52) U.S. Cl. CPC G02F 1/153; G02B 13/16

(57) ABSTRACT

A long-range optical device, in particular monocular, binocular, night-vision device, includes at least one display region for displaying optical information, wherein at least two electrochromic arrangements associated with the at least one display region, which can each be transferred into one or more operating states in order to change the brightness and/or the colorfulness and/or the contrast of respective optical information, and wherein a control device associated with the at least two electrochromic arrangements, which is configured to generate control information for transferring the at least two electrochromic arrangements into one or more respective operating states.

The invention relates to a long-range optical device, in particular monocular, binocular, night-vision device, comprising at least one display region for displaying optical information.

Corresponding long-range optical devices are basically known from the prior art in a variety of different designs and comprise a display region for displaying or viewing optical information.

Likewise, in order to be able to change or adjust the brightness and/or contrast of a corresponding display region—which may, for example, be a viewing area or a field of view of an optical channel of the long-range optical device—it is basically known to equip long-range optical devices with an electrochromic arrangement which comprises an electrochromic element arranged or formed between two electrically conductive elements and formed by or comprising an electrochromic material.

Although correspondingly equipped long-range optical devices offer in a fundamentally satisfactory manner possibilities for changing or adjusting the optical properties, i.e. in particular the brightness and/or the contrast, of a corresponding display region, there is a need for further developed long-range optical devices which open up additional freedom in connection with the possibilities for changing or adjusting the optical properties, i.e. in particular the brightness and/or the contrast, of the at least one display region.

The object underlying the invention is that of providing an improved long-range optical device.

This object is achieved by a long-range optical device according to independent claim 1. The dependent claims relate to possible embodiments of the long-range optical device.

A first aspect of the invention relates to a long-range optical device, which may be, for example, binoculars (monocular or binocular), a telescopic sight, a night-vision device, or thermal observation or aiming optics, etc. The long-range optical device comprises at least one display region for displaying or viewing optical information.

The at least one display region can, for example, be formed by a viewing area or a field of view of an optical channel of the long-range optical device. A corresponding viewing area or a corresponding field of view can therefore be formed, for example, by an optical channel of the long-range optical device. A corresponding optical channel can extend between an objective formed by at least one objective lens and an eyepiece formed by at least one eyepiece lens. Corresponding optical information can therefore be real images, possibly optically magnified, of a target area, target object, etc. observed by means of the long-range optical device.

Alternatively or additionally, the at least one display region can be formed by an electrical or electronic display device, such as a display apparatus. Corresponding optical information may therefore be electrically or electronically generated optical information, e.g. of a target area, target object, etc., observed by means of the long-range optical device. Alternatively or additionally, the corresponding optical information may be alphanumeric and/or graphic information, such as symbols, graphics, images, videos, etc., which have been generated, for example, by a hardware and/or software implemented control device associated with a corresponding electrical or electronic display device.

In all cases, the optical information output by a corresponding electrical or electronic display device can be coupled into the or an optical channel of the long-range optical device via a coupling device, possibly for superimposed display with a real image. A corresponding coupling device can, for example, be formed by a prism arrangement comprising one or more prisms or via a foil arrangement or comprise such an arrangement.

The long-range optical device comprises at least two electrochromic arrangements associated with the at least one display region. Each of the at least two electrochromic arrangements comprises at least one electrochromic element arranged or formed between two electrically conductive elements arranged or formed on respective substrate elements. A corresponding electrochromic element may, for example, be formed by or comprise an electrochromic material. A corresponding electrically conductive element may, for example, be formed by or comprise a contact layer of a conductive material, in particular a conductive metal such as copper. It is conceivable that a corresponding contact layer is applied at least on one side, at least in sections, to an electrically conductive layer or coating arranged or formed on a substrate element body of a respective substrate element. A corresponding electrically conductive layer or coating can, for example, be formed from or comprise a transparent conductive oxide, such as indium tin oxide (ITO).

Each of the at least two electrochromic arrangements can be transferred into one or more operating states in order to change the brightness and/or contrast of respective optical information. Each of the at least two electrochromic arrangements is thus configured to adjust or change the optical properties, i.e. in particular the brightness and/or color and/or contrast, of respective optical information. Changes to the optical properties of respective optical information are made by transferring the respective electrochromic arrangements into respective operating states of the respective electrochromic arrangements; consequently, different operating states of the respective electrochromic arrangements can be correlated with different optical properties of respective optical information.

The long-range optical device is thus characterized by at least two electrochromic arrangements associated with the at least one display region, which can each be transferred into one or more operating states in order to change the optical properties, i.e. in particular the brightness and/or the chromaticity and/or the contrast, of respective optical information. This opens up additional freedom in connection with the possibilities for changing or adjusting the optical properties of the at least one display region. This results in particular from the fact that certain optical properties of the respective optical information can be obtained by transferring the at least two electrochromic arrangements in each case specifically into certain operating states, whereby the at least two electrochromic arrangements each have a certain transmittance (optical transmission) for light of a certain wavelength or a certain wavelength range and associated therewith, a certain brightness, color, contrast, etc., whereby in turn a resulting transmittance for light of a certain wavelength or a certain wavelength range and, associated therewith, a resulting brightness, color, contrast, etc. of the at least two electrochromic arrangements can be realized.

As can be seen from the following, the at least two electrochromic arrangements or at least two electrochromic arrangements of the long-range optical device can be arranged or formed in a series circuit, so that the at least two electrochromic arrangements are arranged or formed directly or indirectly, i.e. with the interposition of at least one other optical element, one behind the other in an optical path, i.e. in particular an optical channel, of the long-range optical device. Alternatively or additionally, the at least two electrochromic arrangements or at least two electrochromic arrangements of the long-range optical device can be arranged or formed in a parallel circuit, so that the at least two electrochromic arrangements are arranged or formed next to each other in an optical path, i.e. in particular an optical channel, or each in an optical path, i.e. in particular an optical channel, of the long-range optical device. Consequently, in the case of a long-range optical device with several optical paths or channels, at least one electrochromic arrangement can be arranged or formed in each optical channel or path.

For transferring the at least two electrochromic arrangements into respective operating states, the long-range optical device comprises at least one control device which is associated with the at least two electrochromic arrangements and implemented in hardware and/or software and which is configured to generate control information for transferring the at least two electrochromic arrangements into one or more operating states. The at least one control device can be configured to generate control information for transferring the at least two electrochromic arrangements into respective operating states. Corresponding control information can, for example, be or be generated on the basis of information or signals generated by user-side inputs and/or information or signals generated by detection or sensor devices, e.g. for detecting the optical properties of an environment around the long-range optical device.

The at least one control device can be arranged or formed on or in a housing part of the long-range optical device. Alternatively or additionally, the or a control device can be arranged or formed in a mobile end device, such as a laptop, smartphone, smart glasses, tablet, etc., or at least one other long-range optical device, such as a target optic, a target range finder, etc., which communicates with the long-range optical device via a wired or wireless data connection. Wireless data connections can be or are implemented via standards for wireless data transmission, such as Bluetooth®.

The transfer of the at least two electrochromic arrangements into respective operating states can be carried out, for example, by applying an electrical voltage or an electrical current to the respective electrochromic arrangement. It is possible that by applying electrical voltages or electrical currents of different levels, possibly varying over time, to a respective electrochromic arrangement, different operating states of the respective electrochromic arrangement can be realized, which are accompanied by different, i.e. in particular differently pronounced, changes in the optical properties of respective optical information. The level of the electrical voltages or electrical currents that can be applied or applied to the respective electrochromic arrangements, possibly varying over time, can be controlled or regulated via the at least one control device as part of a transfer of the respective electrochromic arrangements into respective operating states.

In order to be able to apply electrical voltages or electrical currents to the respective electrochromic arrangements, the long-range optical device can have at least one electrical energy supply device, e.g. in the form of an electrical energy storage device, such as a wired or wirelessly chargeable battery. A corresponding electrical energy supply device can be structurally arranged or formed on or in a housing part of the long-range optical device and can be connected or connected via one or more interfaces to an external energy supply, such as a power grid or an external energy storage device.

If the long-range optical device comprises several display regions, e.g. in a configuration with a first display region formed by an optical channel for a real image and a second display region formed by an electrical or electronic display device for an electrically or electronically generated image, at least one electrochromic arrangement can be associated with each display region. Alternatively, the at least two electrochromic arrangements can be associated with only one (single) display region.

Accordingly, one or more electrochromic arrangements can form an assembly which is structurally arranged or formed within an optical channel of the long-range optical device, in particular within an optical channel extending in an optical tube of the long-range optical device between an objective lens and an eyepiece. Alternatively or additionally, one or more electrochromic arrangements can form an assembly which is structurally arranged or formed outside an optical channel of the long-range optical device, in particular outside an optical channel extending in an optical tube of the long-range optical device between an objective lens and an eyepiece.

Exemplary embodiments of the long-range optical device are explained below, which can in principle be combined with each other as desired:

In one embodiment, the at least two electrochromic arrangements can be transferred into one or more respective operating states depending on or independently of one another. The at least two electrochromic arrangements can thus be transferred into respective operating states depending on or independently of one another. The at least two electrochromic arrangements can thus be put into operation and/or operated depending on or independently of one another. An interdependent transfer of the at least two electrochromic arrangements into respective operating states can mean, for example, that in a case in which a first electrochromic arrangement is transferred into an operating state or is operated in an operating state in which the transmittance for light of a specific wavelength or of a specific wavelength range is increased or decreased by a specific value, a second electrochromic arrangement is switched on or off in response to the change in the transmittance for light of a specific wavelength or of a specific wavelength range of the first electrochromic arrangement and thus depending thereon is transferred to an operating state or is operated in an operating state in which the transmittance for light of a specific wavelength or of a specific wavelength range is likewise increased or decreased by the or another specific value. A mutually independent transfer of the at least two electrochromic arrangements into respective operating states can mean, for example, that in a case in which a first electrochromic arrangement is transferred into an operating state or operated in an operating state in which the transmittance for light of a specific wavelength or of a specific wavelength range is increased or decreased by a specific value, but a second electrochromic arrangement, not in response to the change in the transmittance for light of a specific wavelength or of a specific wavelength range of the first electrochromic arrangement, is independently thereof transferred into an operating state or operated in an operating state, in which the transmittance for light of a specific wavelength or a specific wavelength range is likewise increased or decreased by the or another specific value.

In a further embodiment, by transferring the at least two electrochromic arrangements into respective operating states, a targeted adjustment of the optical properties of the at least one display region can be realized for specific application areas, which can be characterized, for example, by a special environment in which the long-range optical device is used, for example, to observe a target area, target object, etc. For example, for an application of the long-range optical device in an area of high brightness, such as a snowy area, a desert, etc., and/or in an area of certain colorfulness, such as in a forest, on water, etc., a special setting of the optical properties of the at least one display region can be made, which may be automated or controlled automatically via the at least one control device. In this way, for example, a high ambient brightness can be reduced and/or a low ambient contrast can be increased. In an analogous manner, a special setting of the optical properties of the at least one display region, which can be automated or controlled automatically via the at least one control device, can be made alternatively or additionally for an application of the long-range optical device at a particular time of day, month or year.

In a further embodiment, a blocking functionality of the long-range optical device can be implemented by transferring the at least two electrochromic arrangements into respective operating states. A corresponding blocking functionality can include a temporary transfer of the electrochromic arrangements into a respective operating state in which the resulting transmittance for light of a certain wavelength or a certain wavelength range is so low that the optical information cannot be displayed or viewed or cannot be displayed or viewed to the desired extent or in the desired manner. This can be realized, for example, by a targeted darkening, coloring, etc. of the at least one display region or the optical information. A corresponding blocking functionality can therefore include the implementation of a blocking mode in which the resulting transmittance for light of a certain wavelength or a certain wavelength range is so low that the optical information cannot be displayed or viewed or cannot be displayed or viewed to the desired extent or in the desired manner. The cancellation of a blocking mode can be realized, e.g. implemented by the at least one control device, by an authentication or identification of a certain user, e.g. by password entry, user recognition, etc. In a similar way, it may be possible to cancel a blocking mode alternatively or additionally on an external terminal device, such as a laptop, smartphone, smart glass, tablet, etc., or at least one other long-range optical device, such as a target optic, a target range finder, etc.

In a further embodiment, as already mentioned, the at least two electrochromic arrangements can be arranged or formed in an optical channel of the long-range optical device. A corresponding optical channel may, as also mentioned above, extend between an objective lens and an eyepiece of the long-range optical device. The at least two electrochromic arrangements may, for example, be associated with the objective lens, the eyepiece or another optical assembly comprising one or more optical elements arranged or formed within the optical channel, such as a divider cube assembly (if present). In this way, the transmittance of the objective lens, the eyepiece or a corresponding optical assembly for light of a specific wavelength or a specific wavelength range can be changed or adjusted. The at least two electrochromic arrangements can be integrated directly into an objective lens and/or eyepiece of the long-range optical device. Thus, in particular, the substrate elements of the at least two electrochromic arrangements can be configured and/or serve as lens elements of the objective lens and/or the eyepiece of the long-range optical device, whereby a highly integrated optical arrangement is provided.

In a further embodiment in which the long-range optical device has at least two optical channels, such as in a configuration of the long-range optical device as binoculars, at least one first electrochromic arrangement can be arranged or formed in a first optical channel of the long-range optical device and at least one second electrochromic arrangement can be arranged or formed in a second optical channel of the long-range optical device. The optical properties of the at least two optical channels, i.e. in particular the transmittance for light of a specific wavelength or a specific wavelength range, can thus be changed or adjusted depending on or independently of one another by transferring the electrochromic arrangements arranged or formed in these.

In a further embodiment, at least a first electrochromic arrangement can be associated with an optical channel of the long-range optical device to change the brightness and/or the colorfulness and/or the contrast, i.e. generally the transmission for light of a certain wavelength or a certain wavelength range, of the optical information that can be viewed via the optical channel, i.e. for example a real image, and at least a second electrochromic arrangement is associated with an electronic display device, such as a display apparatus, of the long-range optical device to change or adjust the brightness and/or the color and/or the contrast, i.e. generally the transmittance of light of a certain wavelength or a certain wavelength range, of the optical information generated via the electronic display device. As mentioned, the optical information generated by the electrical or electronic display device can be coupled in or coupled in via an optical coupling device, in particular for superimposition with the optical information viewable in the optical channel.

In a further embodiment, a first electrochromic arrangement can be configured in respective one or more operating states for adjusting a defined brightness and/or a defined colorfulness and/or a defined contrast of respective optical information in a first brightness and/or colorfulness and/or contrast range, and a second electrochromic arrangement can be configured in respective one or more operating states for adjusting a defined brightness and/or a defined colorfulness and/or a defined contrast of respective optical information in a second brightness and/or colorfulness and/or contrast range. The second brightness and/or chromaticity and/or contrast range can be the same or different from the first brightness and/or chromaticity and/or contrast range (and vice versa). The chemical and/or physical properties of the electrochromic elements of respective electrochromic arrangements that are used for the adjustment options of a defined brightness and/or a defined chromaticity and/or a defined contrast, i.e. generally the transmittance for light of a specific wavelength or a specific wavelength range, can be the same, so that different electrochromic arrangements can realize, for example, the same brightness and/or chromaticity and/or contrast ranges due to electrochromic elements configured in the same way with respect to their chemical and/or physical properties. In this way, certain ranges of brightness and/or color and/or contrast can be intensified. Alternatively, the chemical and/or physical properties of the electrochromic elements of respective electrochromic arrangements that are used for the adjustment options of a defined brightness and/or a defined chromaticity and/or a defined contrast, i.e. generally the transmittance for light of a specific wavelength or a specific wavelength range, can be different, so that different electrochromic arrangements can realize, for example, different brightness and/or chromaticity and/or contrast ranges due to electrochromic elements configured differently with respect to their chemical and/or physical properties.

In a further embodiment, a first electrochromic arrangement can thus be configured in respective one or more operating states for adjusting a defined chromaticity of respective optical information in a first wavelength range, and a second electrochromic arrangement can be configured in respective one or more operating states for adjusting a defined chromaticity of respective optical information in a second wavelength range. The second chromaticity range or the second color associated therewith can be the same or different from the first chromaticity range or the first color associated therewith (and vice versa). In the case of different chromaticity ranges or colors, these can be complementary, for example. Here, too, the chemical and/or physical properties of the electrochromic elements of the respective electrochromic arrangements that are responsible for the adjustment possibilities of a defined chromaticity or color, i.e. generally the transmittance of light of a certain wavelength or a certain wavelength range, can be the same, so that different electrochromic arrangements can realize, for example, the same chromaticity ranges or color ranges or colors due to electrochromic elements configured in the same way with regard to their chemical and/or physical properties. In this way, certain chromaticity ranges or color ranges or colors can be intensified. Alternatively, the chemical and/or physical properties of the electrochromic elements of respective electrochromic arrangements that are responsible for the adjustment possibilities of a defined chromaticity or color, i.e. generally the transmittance of light of a certain wavelength or a certain wavelength range, can be different, so that different electrochromic arrangements can realize, for example, different chromaticity ranges or color ranges or colors due to electrochromic elements configured differently with respect to their chemical and/or physical properties. As mentioned, the second chromaticity range or color range can be different from the first chromaticity range or color range, whereby the second chromaticity range or color range can be a complementary chromaticity range or color range to the first chromaticity range or color range. This can be useful for hunting applications, for example, because animals can be better distinguished from plants.

In one embodiment, the at least two electrochromic arrangements can be arranged or formed structurally together or integrated in a modular or modular-shaped assembly. A corresponding assembly can, for example, be formed by or comprise a modular or shaped housing device which has a receiving space within which the at least two electrochromic arrangements can be arranged or formed. A corresponding housing device can comprise one or more fastening interfaces via which the housing device can be fastened in a defined orientation and/or position on or in the long-range optical device. Corresponding fastening interfaces can, for example, be mechanical fastening interfaces which enable form-fit and/or force-fit fastening of a corresponding housing device to or in the long-range optical device, i.e. in particular to or in a housing part of the long-range optical device. Alternatively or additionally, it is of course conceivable to attach the housing device to or in the long-range optical device by means of material bonding, i.e. e.g. by adhesive or welding.

As mentioned, each of the at least two electrochromic arrangements typically comprises at least one electrochromic element formed by or comprising an electrochromic material, which is arranged or formed between two electrically conductive elements arranged or formed on a substrate element in each case. With regard to a compact arrangement or integration possibility of the electrochromic arrangements, a further embodiment provides that two electrically conductive elements are arranged or formed on at least one substrate element, in particular on different surfaces, i.e. e.g. an upper side and a lower side, of the at least one substrate element, whereby an electrically conductive element arranged or formed on a first surface, i.e. e.g. an upper side and a lower side, of the at least one substrate element, is arranged or formed between two electrically conductive elements, a first electrically conductive element arranged or formed on a first surface, i.e. e.g. an upper side, of the at least one substrate element is associated with a first electrochromic arrangement, and a second electrically conductive element arranged or formed on a second surface, i.e. e.g. e.g. an underside, of the at least one substrate element is associated with a second electrochromic arrangement.

Certain embodiments of a specific configuration of the electrochromic arrangements of the long-range optical device are described below; the following embodiments apply to at least one, typically all, electrochromic arrangements of the long-range optical device:

As mentioned, a respective electrochromic arrangement generally comprises at least one electrochromic element arranged or formed between two electrically conductive elements-which may form an electrode of the electrochromic arrangement-which is formed by or comprises at least one electrochromic material.

Corresponding electrically conductive elements can be formed by or comprise electrically conductive layers or coatings, i.e. in particular transparent, electrically conductive layers or coatings. In particular, corresponding electrically conductive elements can be formed as transparent, electrically conductive layers or coatings on transparent substrate elements, e.g. made of glass or (transparent) plastic, or comprise such layers or coatings. Consequently, corresponding electrically conductive elements can be applied as an electrically conductive layer or coating on a substrate element or a substrate element body of a substrate element, at least in sections or possibly completely.

A corresponding electrically conductive layer or coating can be, for example, a coating that is formed from or comprises at least one transparent conductive oxide. Specifically, a corresponding electrically conductive layer or coating can be, for example, a layer or coating formed from indium tin oxide (ITO)—as an example of a transparent conductive oxide—or comprising ITO, in short an ITO layer or coating. Transparent conductive oxides, such as ITO, are typically characterized by a comparatively high electrical conductivity (typically 10⁴ S/cm) and a high optical transmission (>90% at a layer thickness of 100 nm) in the visible wavelength range and are therefore particularly suitable for forming corresponding electrically conductive coatings of the electrochromic arrangement described herein.

A corresponding electrochromic element may, for example, be or comprise at least one layer or coating formed from or comprising at least one electrochromic material. An electrochromic material can, for example, undergo a change in its transmission, e.g. by an increase or decrease in its color or color intensity, when an electrical voltage or an electrical current is applied. A corresponding electrochromic material can therefore be regarded as an electrically switchable electrochromic material, for example. Specifically, an electrochromic material can be, for example, a redox-active material, i.e. in particular a redox-active compound, or comprise at least one such material which undergoes a change in its transmission during a redox process, such as a transition from an oxidized to a reduced state (and vice versa). A corresponding redox-active material can be or comprise a metal complex compound, e.g. based on tungsten oxide (WO3), which undergoes a change in its transmission during a redox process, such as a transition from the oxidized to the reduced state (and vice versa). Alternatively or additionally, metallo-supramolecular polyelectrolytes ((FE-)MEPE), for example, can be considered as electrochromic materials. In all cases, a respective electrochromic material can be embedded in an embedding material.

If an electrochromic arrangement comprises several corresponding electrochromic elements, at least one layer or coating of an electrolyte material, in particular a liquid or gel-like electrolyte material, e.g. based on a metal salt, can be arranged or formed between these electrochromic elements.

For making electrical contact with the at least one electrochromic element, i.e. in particular for applying an electrical voltage or an electrical current to the at least one electrochromic element, a corresponding electrochromic arrangement can comprise at least one contact layer made of an electrically conductive material. A particular configuration of a corresponding contact layer is explained in more detail below:

As mentioned, the electrochromic arrangement comprises at least one substrate element made, for example, of glass, such as silicate glass, in particular borosilicate glass, or sapphire glass, or a (transparent) plastic, in particular polycarbonate, polymethyl methacrylate. In this context, a design made of a transparent film material or a transparent film is also conceivable. Although the particular configuration of the at least one contact layer of the electrochromic arrangement used for electrical contacting is described below, in particular in connection with a substrate element, the following explanations apply analogously to each substrate element and each contact layer of each electrochromic arrangement. This is because each electrochromic arrangement generally comprises at least two substrate elements and two corresponding contact layers, which typically have at least a similar, in particular an identical, configuration.

A respective substrate element typically consists of a substrate element body. The substrate element body has a basic shape that can be integrated into an optical tube of a long-range optical device. Consequently, shape-determining geometric-constructive parameters, such as dimensions, of the substrate element body are typically selected with regard to the installation space available in a long-range optical device for proper integration.

Since the at least two electrochromic arrangements can typically be arranged or are to be arranged within an optical tube of a long-range optical device, the geometric-constructive parameters of the respective substrate element bodies are typically selected with regard to the installation space available in an optical tube. In this respect, substrate element bodies with a circular disk-like or circular basic shape are particularly suitable. Each substrate element body is therefore typically configured in the shape of a circular disk. However, other configurations, such as disk-like or disk-shaped substrate element bodies with a polygonal, i.e. triangular, square, pentagonal, hexagonal, heptagonal, octagonal, ninagonal, decagonal, eleven-cornered or dodecagonal basic shape, are also conceivable.

Each substrate element body can be configured in a disk-like or disk-shaped manner and therefore have an upper side and a lower side, which individually or jointly define a main extension plane of the respective substrate element body. In addition to the electrically conductive layer or coating mentioned above, the contact layer, also mentioned above, made of an electrically conductive material, such as a metal, in particular a precious metal, such as gold, or a semi-precious metal, such as copper, is arranged or formed on the upper and/or lower side of a respective substrate element body. The or a contact layer is typically applied by a chemical and/or physical application process, in particular a chemical and/or physical deposition process, further in particular a chemical and/or physical vapor deposition process, to the top and/or bottom of the respective substrate element body of the at least one substrate element. Application by means of spin coating is also conceivable as an example of a corresponding application process.

The layer thickness of the contact layer can be in a range between 1 nm and 1000 nm, in particular in a range between 1 nm and 950 nm, further in particular in a range between 1 nm and 900 nm, further in particular in a range between 1 nm and 900 nm, further in particular in a range between 1 nm and 850 nm, further in particular in a range between 1 nm and 800 nm, further in particular in a range between 1 nm and 750 nm, further in particular in a range between 1 nm and 700 nm, further in particular in a range between 1 nm and 650 nm, further in particular in a range between 1 nm and 600 nm, further especially in a range between 1 nm and 550 nm, further especially in a range between 1 nm and 500 nm, further especially in a range between 1 nm and 450 nm, further especially in a range between 1 nm and 400 nm, further especially in a range between 1 nm and 350 nm, further especially in a range between 1 nm and 300 nm, further in particular in a range between 1 nm and 250 nm, further in particular in a range between 1 and 200 nm, further in particular in a range between 1 nm and 150 nm, further in particular in a range between 1 nm and 100 nm, further in particular in a range between 1 nm and 50 nm. Instead of 1 nm, 2 nm, 3 nm, 4 nm, 5 nm, 6 nm, 7 nm, 8 nm, 9 nm or 10 nm, for example, could also be used as the respective lower limit. In principle, all of the aforementioned values can also be used individually or as upper or lower limits of a layer thickness interval.

The contact layer can be applied directly or indirectly to the upper and/or lower side of the respective substrate element body. In the first alternative, a corresponding transparent, electrically conductive layer or coating is also arranged or formed on the upper and/or lower side of the substrate element body; the transparent, electrically conductive layer or coating can be arranged or formed in particular in areas on the upper and/or lower side of the substrate element body in which the contact layer does not extend. In the second alternative, a corresponding transparent, electrically conductive layer or coating is arranged or formed on the upper and/or lower side of the substrate element body, in particular over the entire surface, and the contact layer is arranged or formed at least in sections on the transparent, electrically conductive layer or coating.

A respective contact layer can extend in a ring-like or ring-shaped manner, i.e. in particular in a ring-segment-like or ring-shaped manner, at least in sections around the edge or along the edge of the respective substrate element body, which, as mentioned, has a circular disk-like or circular basic shape, for example. A respective contact layer can thus be configured as an electrically conductive layer extending at least in sections, if necessary completely, around the edge or along the edge of the substrate element body. A respective contact layer can thereby be a continuous, quasi-continuous or discontinuous electrically conductive layer; consequently, a respective contact layer can be a continuous, quasi-continuous or discontinuous electrically conductive layer running around the edge or along the edge of the substrate element body.

A respective substrate element body is therefore not provided with a contact layer over its entire upper and/or lower surface, but only in a section of the upper or lower surface surrounding the edge. This results not only in advantages with regard to reliable electrical contacting of the respective electrochromic arrangement with an electrical power supply, such as a battery integrated in the long-range optical device, but also with regard to the application of an electrical voltage to the at least one electrochromic element, which occurs at least temporarily during operation of the respective electrochromic arrangement, when the latter is contacted in a ring-like or ring-shaped manner.—This leads to a particularly rapid and uniform change in the optical properties, i.e. in particular the transmission, of the electrochromic arrangement in a surprising manner, particularly in contrast to contacting only at a point. The described arrangement or formation of the electrically conductive layer also enables a change in brightness or contrast largely circumferentially from “outside to inside” and excludes phenomena known from the prior art, such as coloration in the manner of a stage curtain. In addition, there are, for example, production-related advantages in that the at least one substrate element does not have to be provided with a contact layer over its entire surface in the area of the upper or lower side of the substrate element body, but only in the area of the edge.

As mentioned, a corresponding contact layer extends in a ring-like or ring-shaped manner, in particular in a ring-segment-like or ring-shaped manner, i.e. with a ring-like or ring-shaped or ring-segment-like or ring-shaped basic shape, at least in sections around the edge or along the edge of a respective substrate element body which, as mentioned, typically has a circular disk-like or circular basic shape. The contact layer can extend around at least 25%, in particular around at least 30%, in particular around at least 35%, in particular around at least 40%, in particular around at least 45%, in particular around at least 50%, in particular around at least 55%, in particular around at least 60%, in particular around at least 65%, in particular around at least 70%, in particular around at least 75%, in particular around at least 80%, in particular around at least 85%, in particular around at least 90%, in particular around at least 95%, possibly even 100%, of the edge around or along the edge of the substrate element body. along the edge of the substrate element body (the above-mentioned values can also be regarded as upper or lower limits of intervals). The more completely the contact layer extends around the edge or along the edge of a respective substrate element body, the faster or more uniformly a change in the optical properties, i.e. in particular the transmission, of the electrochromic arrangement can be brought about. In this respect, the contact layer therefore typically extends by at least 50% around the edge or along the edge of the respective substrate element body.

At this point, conceivable values for the width of a contact layer formed in the form of a ring (segment) or segment are also given by way of example; the width of the contact layer can therefore be, for example 0.1 mm, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm (the above values can also be regarded as upper or lower limits of intervals).

Between the contact layer and the edge of a respective substrate element body, there can be a defined free space, at least in sections, in which the contact layer does not extend. Consequently, the contact layer does not have to extend completely to the edge of the respective substrate element body at least in sections with respect to its radial extension (with respect to a symmetry or central axis of the substrate element body), but there can be a defined distance between the outer circumference of the contact layer, which, as mentioned, is configured in particular in the form of a ring (segment) or segment, and the actual edge of the upper or lower side of the respective substrate element body. The contact layer can therefore be at least in sections with a defined distance, e.g. of 0.1 mm, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm (the above-mentioned values can also be regarded as upper or lower limits of intervals), to the edge of the upper or lower side of the respective substrate element body. In this way, for example, the material used to form the contact layer and thus the time required to apply the contact layer to the upper or lower side of the respective substrate element body can be reduced.

As mentioned, the contact layer is used in particular for contacting a respective electrochromic arrangement with an electrical power supply. The contact layer can therefore comprise a contact section of the electrochromic arrangement that can be contacted by an electrical contact element, such as a wire, a stranded wire, a cable, a spring contact, a pin contact, etc., that can be connected or connected to the electrical power supply.

A corresponding contact section can, for example in order to ensure reliable contacting with a corresponding electrical contact element, have different dimensions than the other regions of the contact layer, in particular with regard to its radial extension in the direction of the edge of the upper or lower side of the respective substrate element body. The contact section can therefore be formed by or represent a radial extension of the contact layer (compared to the other areas of the contact layer), which extends in the circumferential direction around a certain area of the edge of the substrate element body, i.e. e.g. by at least 5%, in particular by at least 10%, further in particular by at least 15%, further in particular by at least 20%, further in particular by at least 25%, further in particular by at least 30%, further in particular by at least 35%, further in particular by at least 40%, further in particular by at least 45%, further in particular by at least 50%, circumferentially around or along the edge of the respective substrate element body. There is typically no corresponding electrically conductive layer or coating in the area of a corresponding contact section; consequently, the contact section can be applied directly to the upper or lower side of the respective substrate element body.

With regard to a simple as well as stable structural integration of a respective electrochromic arrangement into the long-range optical device, i.e. in particular into a corresponding optical tube of the long-range optical device, the edge of the respective substrate element body can have at least one flattening. A corresponding flattening can in particular be defined by a line or straight line running through at least two points on the edge of the respective substrate element body forming the outer circumference of the respective substrate element body. Further in particular, a corresponding flattening can be defined by a secant running through at least two points on the edge of the respective substrate element body forming the outer circumference of the respective substrate element body. The shape of the respective substrate element body need not therefore be a complete circular disk since the edge of the respective substrate element body can have at least one corresponding flattening. A corresponding flattening of the respective substrate element body can likewise simplify the structural integration of the electrochromic arrangement into the long-range optical arrangement, for example as the flattening can be used to realize an anti-rotation lock of the electrochromic arrangement in an optical tube of the long-range optical device.

Similarly, a corresponding flattening can form a functionalized interface of a respective electrochromic arrangement, as, as will be shown below, a special electrical contacting option of the respective electrochromic arrangement with an electrical power supply can be realized in this way. This applies in particular if the contact section is arranged or formed opposite the flattening of the respective substrate element body. The contact section and the flattening can thus be arranged or formed (essentially) offset by 180° in the circumferential direction with respect to the, as mentioned, in particular circular disk-like or circular basic shape of the respective substrate element body. In a top view of the corresponding upper or lower side of the respective substrate element body, the contact section can thus be arranged or formed at the top, for example, and the flattening can be arranged or formed opposite at the bottom.

In an arrangement which is expedient with regard to contacting a respective electrochromic arrangement with an electrical power supply because it is particularly compact, a respective electrochromic arrangement comprises two substrate elements which each have a substrate element body with a corresponding flattening and an electrical contact section arranged or formed opposite the flattening. The substrate element bodies of the first substrate element and the second substrate element can be arranged one above the other, with their contact layers facing each other, but cannot make electrical contact with each other in order to avoid short circuits. The respective contact layers can lie on top of each other in such a way that they can complement each other to form a closed ring; consequently, the contact layer arranged or formed on the substrate element body of a first substrate element can (also) extend in the circumferential direction in an area in which no contact layer extends on the substrate element body of a second substrate element. Typically, the superimposed arrangement of the substrate elements is also selected such that their respective contact sections are at least partially exposed, so that the electrochromic arrangement can be contacted with the electrical power supply both via the contact section of the first substrate element and via the contact section of the second substrate element. A first electrical contact element can connect the contact section of the contact layer of a first substrate element to the electrical power supply and a second electrical contact element can connect the contact section of the contact layer of a second substrate element to the electrical power supply.

The at least one electrochromic element of a respective electrochromic arrangement, which, as mentioned above, can be a layer or coating of an electrochromic material, can also be arranged or formed on the respective substrate element body, whereby it covers the contact layer and the layer or coating of the electrically conductive material, which may also be arranged or formed on the respective upper or lower side of the respective substrate element body, at least in sections, in particular completely.

A respective electrochromic arrangement can also have at least one spacer element made of an electrically insulating material, such as a plastic, which is arranged or formed at least in sections, if necessary completely, on the at least one electrochromic element. The at least one spacer element can have a ring-like or ring-shaped basic shape. The outer dimensions of a spacer element having a corresponding ring-like or ring-shaped basic shape can correspond to the outer dimensions of the respective substrate element body, so that the spacer element lies flush on the respective substrate element body. Within the interior space defined by the ring-like or ring-shaped basic shape of the at least one spacer element, the aforementioned layer or coating of an electrolyte material can be arranged or formed. In particular, the respective spacer elements are configured to distance or separate the respective contact layers from each other so that they cannot make electrical contact.

A further embodiment of an electrochromic arrangement is described below:

The electrochromic arrangement in turn comprises at least one substrate element with a substrate element body. The substrate element body typically has a basic shape that can be integrated into an optical tube of a long-range optical device. Consequently, shape-determining geometric-constructive parameters, such as the dimensions, shape, etc., of the substrate element body are typically selected with regard to the installation space available in a long-range optical device for the intended integration of the electrochromic arrangement.

The substrate element or the substrate element body is typically formed from a transparent material. Specifically, the substrate element or the substrate element body can therefore be made of glass, in particular sapphire glass, silicate glass, further in particular borosilicate glass, etc., or of a (transparent) plastic, in particular polycarbonate, polymethyl methacrylate. In this context, a design made of a transparent film material or a transparent film is also conceivable.

The substrate element body typically has one or more surfaces. At least one surface is formed to be inclined or curved at least in sections, if necessary completely. As will be seen below, the at least partially inclined or curved surface is typically associated with or forms an upper side of the substrate element body.

As can be seen from the following, the substrate element body can typically have at least one surface which is planar at least in sections, in particular from a manufacturing point of view. The substrate element body can thus have at least one planar base section formed by a planar surface or a planar surface section of the substrate element body. Depending on the specific design of the substrate element body, the planar base section can be arranged or formed, for example, parallel or at an angle to at least one other surface of the substrate element body. The planar base section can thus, for example, be associated with or form a first side, in particular an upper side, of the substrate element body, whereas the other surface can be associated with or form a second side, in particular a lower side, of the substrate element body.

The substrate element body can, for example, have a disk-like or disk-shaped basic shape, in particular a circular disk-like or circular basic shape. The substrate element or the substrate element body can therefore be a disk-like or disk-shaped component, in particular a circular disk-like or circular-shaped component. This is a comparatively compactly configured embodiment with regard to its spatial volume. If the substrate element or the substrate element body is configured as a (circular) disk-like or disk-shaped component, a corresponding planar base section can be formed, for example, by an upper side or in the area of an upper side of the substrate element body.

Alternatively, the substrate element body can, for example, have a polygonal basic shape. The substrate element or the substrate element body can therefore be a polygonal or polygonal component. In particular, the substrate element or the substrate element body can be a prism, in particular a prism forming a component of an optical beam splitter, such as a beam splitter cube. This is a highly integrated embodiment with regard to the integration of various optical functions. If the substrate element or the substrate element body is configured as a polygonal or polygonal component, a corresponding planar base section can be formed, for example, by an outer surface or in the area of an outer surface of the substrate element body.

At least one electrochromic element formed from or comprising at least one electrochromic material is arranged or formed on a surface of the substrate element body—a corresponding surface may be, for example, an outer surface of the substrate element body, in particular an outer surface of the substrate element body forming an upper or lower side of the substrate element body. This surface of the substrate element body may be the aforementioned surface, i.e. in particular the aforementioned planar surface, or the surface of the substrate element body may have the aforementioned planar base section. If the at least one electrochromic element is arranged or formed on an outer surface of the substrate element body forming an upper surface of the substrate element body, the surface of the substrate element body opposite this outer surface, i.e. an outer surface of the substrate element body forming the underside of the substrate element body, can be formed with a convex or concave curvature, i.e. generally with an optically effective shaping. Conversely, if the at least one electrochromic element is arranged or formed on an outer surface of the substrate element body forming an underside of the substrate element body, the surface of the substrate element body opposite this outer surface, i.e. an outer surface of the substrate element body forming the upper side of the substrate element body, can be formed with a convex or concave curvature, i.e. generally with an optically effective shaping.

In this context, it should again be mentioned in general terms that a respective substrate element can also form a component of an optically effective device, such as a prism, dividing cube, etc.

If the electrochromic arrangement has several substrate elements, the respective substrate elements can be provided with electrochromic elements differing in at least one chemical parameter, such as the chemical composition, and/or physical parameter, such as the layer thickness. In particular, the electrochromic elements arranged or formed on different substrate elements can differ in their electrochromic properties, i.e. for example in their color, their contrast, etc.

The surface of the substrate element body, on which the at least one electrochromic element is arranged or formed, can be provided in the region of the (outer or lateral) edge at least in sections, in particular completely, with a circumferentially inclined or curved section. The surface of the substrate element body, on which the at least one electrochromic element is arranged or formed, can thus have a first section (first surface section) and a second section (second surface section). The first section forms the or a base section of the substrate element body. The second section forms an (outer) edge section of the substrate element body at least partially, in particular completely, surrounding the base section and is curved or inclined, in particular with respect to the base section. In the form of the second section, the substrate element body can therefore have an edge section that is, for example, concave or convex, curved or inclined. The first section, on the other hand, is typically planar; the first section therefore typically forms the aforementioned planar surface or the planar surface section of the substrate element body.

The substrate element body can thus have two different cross-sectional configurations when viewed cross-sectionally, namely a first cross-sectional configuration formed by the first section, i.e. the base section, and a second cross-sectional configuration formed by the second section, i.e. the curved or inclined edge section.

Compared to the first section, the second section typically has reduced dimensions, i.e. in particular a reduced height, which provides a particularly space-saving electrical contacting option for the electrochromic arrangement, since an electrical contact element can be arranged or formed on the second section, i.e. in particular on a surface of the second section, without having to change the dimensions, i.e. in particular the height, of the electrochromic arrangement. The dimensions, i.e. in particular the height, of the electrochromic arrangement—this applies in particular to designs with (circular) disk-like or disk-shaped substrate element bodies, but in principle also to all other designs—can therefore be (essentially) determined by the dimensions, i.e. in particular the height, of the substrate element body or bodies of the electrochromic arrangement.

As mentioned, the at least one electrochromic element is arranged or formed at least on the first section of the surface of the substrate element body; however, it is conceivable that the at least one electrochromic element is also arranged or formed on the second section of the surface of the substrate element body; the at least one electrochromic element can thus extend (only) at least in sections, optionally completely, over the first section of the surface of the substrate element body or extend both at least in sections, optionally completely, over the first section and at least in sections, optionally completely, over the second section of the surface of the substrate element body.

The at least one electrochromic element can be arranged or formed on an electrically conductive layer or coating; consequently, the first section of the surface of the substrate element body can be provided at least in sections, in particular completely, with an electrically conductive layer or coating on which the at least one electrochromic element is arranged or formed. Similarly, the second section of the surface of the substrate element body can be provided at least in sections, possibly completely, with an electrically conductive layer or coating on which the at least one electrochromic element can be arranged or formed. A corresponding electrically conductive layer or coating can, for example, be a coating which is formed from at least one transparent conductive oxide or comprises at least one such oxide; the explanations below on transparent conductive oxides apply analogously.

The electrochromic material can, for example, change its transmission, e.g. by increasing or decreasing its color or color intensity, when an electrical voltage or an electrical current is applied. The electrochromic material can therefore be regarded as an electrically switchable electrochromic material, for example. Specifically, the electrochromic material can be, for example, a redox-active material, i.e. in particular a redox-active compound, or comprise at least one such material which undergoes a change in its transmission during a redox process, such as a transition from an oxidized to a reduced state (and vice versa). A corresponding redox-active material can be a metal complex compound, e.g. based on tungsten oxide (WO3), nickel oxide (NiO), molybdenum oxide (MoO3), Mnm+ [Fe(III)Fe(II)(CN)]63 15 H2 O (Berlin blue or Prussian blue) or titanium oxide. Prussian blue) or titanium oxide (TiO2), which undergoes a change in its transmission during a redox process, such as a transition from the oxidized to the reduced state (and vice versa). Alternatively or additionally, conjugated polymer molecules, such as PEDOT, amine derivatives, such as triphenylamine derivatives, polyimides, metallo-supramolecular polyelectrolytes ((FE-)MEPE) can be considered as electrochromic materials. A change in the transmission of the electrochromic material can be accompanied by a change in the color and/or the reflection or mirroring properties for light of certain properties of the electrochromic material and thus of the at least one electrochromic element.

As mentioned, in the case of embodiments of the electrochromic arrangement, substrate elements may be provided with electrochromic elements differing in at least one chemical parameter, such as the chemical composition, and/or physical parameter, such as the layer thickness. In particular, the electrochromic elements arranged or formed on different substrate elements can differ in their electrochromic properties, i.e. for example in their color, contrast, etc. Specifically, a first electrochromic element applied to a first substrate element can be based, for example, on tungsten oxide (WO3) and a second electrochromic element applied to a second substrate element can be based, for example, on titanium oxide (TiO2). Other configurations are conceivable.

The at least one electrochromic element may be or comprise at least one layer or coating. The layer or coating may be formed from the at least one electrochromic material or comprise at least one such material. The thickness of the layer or coating can be in a range between 1 nm and 2000 nm, in particular in a range between 1 nm and 1950 nm, further in particular in a range between 1 nm and 1900 nm, further in particular in a range between 1 nm and 1850 nm, further in particular in a range between 1 nm and 1800 nm, further particularly in a range between 1 nm and 1750 nm, further particularly in a range between 1 nm and 1700 nm, further particularly in a range between 1 nm and 1650 nm, further particularly in a range between 1 nm and 1600 nm, further particularly in a range between 1 nm and 1550 nm, further in particular in a range between 1 nm and 1500 nm, further in particular in a range between 1 nm and 1450 nm, further in particular in a range between 1 nm and 1400 nm, further in particular in a range between 1 nm and 1350 nm, further in particular in a range between 1 nm and 1300 nm, further in particular in a range between 1 nm and 1250 nm, further in particular in a range between 1 and 1200 nm, further in particular in a range between 1 nm and 1150 nm, further in particular in a range between 1 nm and 1100 nm, further in particular in a range between 1 nm and 1050 nm, further in particular in a range between 1 nm and 1000 nm, further in particular in a range between 1 nm and 950 nm, further in particular in a range between 1 nm and 900 nm, further in particular in a range between 1 nm and 850 nm, further in particular in a range between 1 nm and 800 nm, further in particular in a range between 1 nm and 750 nm, further in particular in a range between 1 nm and 700 nm, further in particular in a range between 1 nm and 650 nm, further in particular in a range between 1 nm and 600 nm, further in particular in a range between 1 nm and 550 nm, further in particular in a range between 1 nm and 500 nm, further in particular in a range between 1 nm and 450 nm, further in particular in a range between 1 nm and 400 nm, further in particular in a range between 1 nm and 350 nm, further in particular in a range between 1 nm and 300 nm, further in particular in a range between 1 nm and 250 nm, further in particular in a range between 1 and 200 nm, further in particular in a range between 1 nm and 150 nm, further in particular in a range between 1 nm and 100 nm, further in particular in a range between 1 nm and 50 nm. Instead of 1 nm, 2 nm, 3 nm, 4 nm, 5 nm, 6 nm, 7 nm, 8 nm, 9 nm or 10 nm, for example, could also be used as the respective lower limit. In principle, all of the aforementioned values can also be used individually or as upper or lower limits of a layer thickness interval.

The layer thickness can also be in the micrometer range if necessary, so that all of the aforementioned layer thicknesses or layer thickness ranges can also be in the micrometer unit. Correspondingly high layer thicknesses can be realized, for example, through multiple coating processes.

The at least one electrochromic element can form an electrode of the electrochromic arrangement and be arranged or formed between two electrically conductive elements.

Corresponding electrically conductive elements can be formed by or comprise electrically conductive layers or coatings, i.e. in particular transparent, electrically conductive layers or coatings. In particular, corresponding electrically conductive elements can be formed as transparent, electrically conductive layers or coatings on the surface of the substrate element body or comprise such layers or coatings. Consequently, corresponding electrically conductive elements can be applied to the surface of the substrate element body as an electrically conductive layer or coating, at least in sections or, if necessary, completely. Corresponding electrically conductive layers or coatings can also be referred to as contact layers. A corresponding contact layer typically extends in a ring-like or ring-shaped manner, at least in sections, around the edge or along the edge of the substrate element body, which, as mentioned, has a circular disk-like or circular basic shape, for example. The contact layer can thus be configured as an electrically conductive layer or coating that extends at least in sections, possibly completely, around the edge or along the edge of the substrate element body. A corresponding contact layer can be a continuous, quasi-continuous or discontinuous electrically conductive layer; consequently, a corresponding contact layer can be a continuous, quasi-continuous or discontinuous electrically conductive layer running around the edge or along the edge of the substrate element body. The layer thicknesses of corresponding electrically conductive layers or coatings or contact layers can be analogous to the layer thicknesses of the layer or coating of the at least one electrochromic material listed above as examples.

A corresponding electrically conductive layer or coating can specifically be, for example, a coating that is formed from or comprises at least one transparent conductive oxide. For example, a corresponding electrically conductive layer or coating can be, for example, a coating formed from indium tin oxide (ITO)—as an example of a transparent conductive oxide—or a coating comprising ITO, in short an ITO coating. Transparent conductive oxides, such as ITO, are typically characterized by a comparatively high electrical conductivity (typically 10⁴ S/cm) and a high optical transmission (>90% at a layer thickness of 100 nm) in the visible wavelength range and are therefore particularly suitable for forming corresponding electrically conductive coatings of the electrochromic arrangement described herein.

If the electrochromic arrangement comprises several electrochromic elements, at least one layer or coating of an electrolyte material, in particular a liquid or gel-like electrolyte material, e.g. based on a metal salt, can be arranged or formed between these electrochromic elements. The layer thickness of the at least one layer or coating of the electrolyte material can be in a range between 1 and 2000 μm, in particular the layer thickness of the at least one layer or coating of the electrolyte material is in a range between 10 and 1000 μm, further in particular between 100 and 500 μm.

Returning to the geometric-constructive design of the surface of the substrate element body in an embodiment with a corresponding first section and a corresponding second section, the latter being curved or inclined, the following may also apply:

If the second section is formed to be inclined, i.e. forms or comprises an inclined surface, the second section or the inclined surface may extend at an angle from a range between 91 and 179° with respect to the first section, in particular the exposed surface of the, as mentioned, typically planar first section. Specifically, the angle of the inclined surface can have a value of: 91°, 92°, 93°, 94°, 95°, 96°, 97°, 98°, 99° 100°, 111°, 112°, 113°, 114°, 115°, 116°, 117°, 118°, 119°, 120°, 121°, 122°, 123°, 124°, 125°, 126°, 127°, 128°, 129°, 130°, 131°, 132°, 133°, 134°, 135°, 136°, 137°, 138°, 139°, 140°, 141°, 142°, 143°, 144°, 145°, 146°, 147°, 148°, 149°, 150°, 151°, 152°, 153°, 154°, 155°, 156°, 157°, 158°, 159°, 160°, 161°, 162°, 163°, 164°, 165°, 166°, 167°, 168°, 169°, 170°, 171°, 172°, 173°, 174°, 175°, 176°, 177°, 178°, 179° with respect to the first section, in particular the exposed surface of the, as mentioned, typically planar first section. At least two of the aforementioned values can also form limit values of angular ranges, so that the second section or the inclined surface extends, for example, at an angle from a range of 95-150°, in particular 105-145°, further in particular 125-140°, with respect to the first section, in particular the exposed surface of the, as mentioned, typically planar first section. Thus, by selecting a corresponding angle or angle range, there is basically a design parameter for realizing a desired electrical contacting of the electrochromic arrangement; in particular, the angle or angle range can be selected with regard to the geometric-constructive configuration of an electrical contact element in order to realize an electrical contacting that is as planar as possible.

If the second section is curved, i.e. forms or has a convex or concave curved surface, the second section or the curved surface can have a radius of between 5° and 45°. Specifically, the radius of the curved surface can have a value of 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45° to 90°. At least two of the aforementioned values can also form limit values of radius ranges, so that the second section or the curved surface can, for example, have a radius from a range of 15-45°, in particular 20-40°, further in particular 25-35°. Consequently, by selecting a corresponding radius or radius range, there is basically a design parameter for realizing a desired electrical contacting of the electrochromic arrangement; in particular, the radius or radius range can be selected with regard to the geometric-constructive configuration of an electrical contact element in order to realize an electrical contacting that is as flat as possible. In principle, all of the aforementioned values can also be used on their own or as the respective upper or lower limits of an angle interval.

Alternatively or additionally, the curved second section can lie on a circular radius, depending on the radial dimensions of the substrate element body—this applies in particular to substrate element bodies with a rotationally symmetrical basic shape—on a radius, for example, from a range between 0.5 mm and 30 mm. The circle radius can refer to an imaginary circle whose center lies on an imaginary line extending axially through the center of the substrate element body. The radius can therefore be, for example be: 0.5 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, 25.5 mm, 26 mm, 26.5 mm, 27 mm, 27.5 mm, 28 mm, 28.5 mm, 29 mm, 29.5 mm, 30 mm. In principle, all of the aforementioned values can also be used individually or as the respective upper or lower limits of a radius interval.

A further design parameter that is important for the realization of the desired electrical contacting of the at least one electrochromic element can be the length or the radial extension (for rotationally symmetrical surfaces, for example in the case of a circular disk-like or circular disk-shaped design of the substrate element body) of the second section; the length of the second section can be a further parameter that is important for the realization of the desired electrical contacting of the at least one electrochromic element. or circular disk-shaped design of the substrate element body) of the second section; the length of the second section can generally be at least 1 mm, in particular at least 2 mm, further in particular at least 3 mm, further in particular at least 4 mm, further in particular at least 5 mm, further in particular at least 6 mm, further in particular at least 7 mm, further in particular at least 8 mm, further in particular at least 9 mm, further in particular at least 10 mm, further in particular at least 11 mm, further in particular at least 12 mm, further in particular at least 13 mm, further in particular at least 14 mm, further in particular at least 15 mm, further in particular at least 16 mm, further in particular at least 17 mm, further in particular at least 18 mm, further in particular at least 19 mm, further in particular at least 20 mm. In principle, all of the aforementioned values can also be used for themselves or as the respective upper or lower limits of an interval.

The radial dimensions of the second section can be at least 1%, in particular at least 2%, further in particular at least 3%, further in particular at least 4%, further in particular at least 5%, further in particular at least 6%, further in particular at least 7%, further in particular at least 8%, further in particular at least 9%, further in particular at least 10%, further at least 11%, in particular at least 12%, further in particular at least 13%, further in particular at least 14%, further in particular at least 15%, further in particular at least 16%, further in particular at least 17%, further in particular at least 18%, further in particular at least 19%, further in particular at least 20%, of the diameter of the substrate element body; as mentioned, this applies in particular to rotationally symmetrical substrate element bodies, i.e. i.e. e.g. for (circular) disk-like or disk-shaped substrate element bodies. In principle, all the aforementioned values can also be used on their own or as the respective upper or lower limits of an interval.

As mentioned, the first section can be provided at least in sections, in particular completely, with an electrically conductive layer or coating on which the at least one electrochromic element is arranged or formed. An electrically conductive coating can thus be arranged or formed between the at least one electrochromic element and the surface of the substrate element body, which may extend completely over the corresponding surface of the substrate element body. In principle, various techniques can be considered for applying an electrically conductive layer or coating, which can be used to influence or control the extension of the electrically conductive layer or coating over the surface of the substrate element body. Rotational coating processes, spraying processes, dipping processes, etc. are merely examples in this context; in principle, chemical and/or physical deposition processes, such as gas phase deposition processes, or printing processes, such as pad printing processes, are also possible. Accordingly, electrically conductive layers can be applied to the surface of the substrate element body, for example by rotary coating processes, spraying processes, dipping processes, or chemical and/or physical deposition processes. Versions of the at least one electrochromic element as a layer or coating can be applied in an analogous manner.

However, it may be noteworthy that the outermost edge of the surface of the substrate element body is not provided with a corresponding electrically conductive layer or coating, because the outermost edge is covered at least in sections by one or more retaining elements during the application process, which can locally prevent the application of an electrically conductive layer or coating. It is nevertheless conceivable that these areas are also provided with an electrically conductive layer or coating in a separate application process.

The electrochromic arrangement may comprise at least one electrical contact element for electrically contacting the at least one electrochromic element with an electrical energy source or supply. Specifically, the at least one electrical contact element—this can be or comprise, for example, a wire, a cable, a contact ring, a stranded wire, etc.—can be contacted with a corresponding electrically conductive layer or coating, as mentioned, which can also be referred to as an electrical contact layer. The electrical contact element can make electrical contact with an exposed section of the electrically conductive layer or coating, which is arranged or formed in particular in the region of the second section of the surface of the substrate element body.

Since the second section of the surface of the substrate element body is typically provided with the electrically conductive layer or coating over the entire surface, very uniform electrical contacting of the at least one electrochromic element can take place, which in turn leads to a very uniform change in the optical properties during operation. The described arrangement or design of the electrically conductive layer or coating therefore enables a change in brightness or contrast largely circumferentially from “outside to inside” and excludes any undesirable phenomena, such as discoloration in the manner of a stage curtain.

The second portion of the surface of the substrate element body may have a different roughness than the first portion of the surface of the substrate element body. In particular, the second section may have a lower roughness than the first section of the surface of the substrate element body. In this way, a very constant application of the electrically conductive layer or coating can be ensured, for example with regard to the layer thickness, which in turn can bring advantages in connection with the electrical contacting of the at least one electrochromic element. Specifically, the second section of the surface of the substrate element body can have a surface specification of P1, P2, P3 or P4 in accordance with DIN ISO 10110-8. In particular, a surface specification of P2, P3 or P4, especially P3 or P4, according to DIN ISO 10110-8 can be considered. The surface specification of the first section is correspondingly lower; for example, the surface specification of the first section can be P3 in accordance with DIN ISO 10110-8 and the surface specification of the second section can be P2 in accordance with DIN ISO 10110-8.

The electrochromic arrangement typically comprises several substrate elements or substrate element bodies, each of which has a surface with a corresponding first and second section. The substrate elements or substrate element bodies are typically arranged on top of each other in a stack-like or stack-shaped manner, so that the respective surfaces with a corresponding first and second section are opposite each other. In particular, the substrate elements or substrate element bodies are arranged on top of each other in a stacked or stack-shaped manner, so that their respective second sections face each other, forming a wedge-like or wedge-shaped intermediate space when viewed cross-sectionally. The intermediate space also forms a spatial volume for compact electrical contacting of the respective substrate elements or the associated electrochromic elements with an electrical contact element. However, any contact layers of the respective substrate elements or substrate element bodies typically do not contact each other in order to avoid short circuits. At least one electrolyte layer, in particular a liquid or gel electrolyte layer, made of an electrolyte material, e.g. based on a metal salt, can be arranged or formed between the respective electrochromic elements.

A corresponding stack-like or stack-shaped arrangement of respective substrate element bodies on top of each other is also conceivable if the outer surfaces of the substrate element bodies facing each other do not have flat sections, but are curved, for example. In this case, the curvatures of the substrate element bodies are typically configured in a corresponding or opposing manner, which enables a stack-like or stack-shaped arrangement of respective substrate element bodies on top of each other.

The at least two substrate elements can be embedded in or surrounded by an insulating material, in particular an electrically and/or thermally insulating potting compound, for example based on a plastic or plastic resin, at least in sections. In this way, the electrochromic elements, but also corresponding contact layers, can be protected from external influences, e.g. electrical, climatic, mechanical or thermal influences.

The entire electrochromic arrangement can be arranged in a receiving or housing part. In particular, the at least two substrate elements can be arranged in a receiving space of a corresponding receiving or housing part and embedded in a corresponding insulating material in this receiving space, e.g. by encapsulation. A corresponding receiving or housing part thus typically not only provides additional protection against corresponding external influences, but can also improve the handling of the electrochromic arrangement, for example during assembly in a long-range optical device.

The electrochromic arrangement can have at least one spacer element made of an electrically insulating material, such as a plastic, which is arranged or formed at least in sections, if necessary completely, on the at least one electrochromic element. The at least one spacer element can have a ring-like or ring-shaped basic shape. The outer dimensions of the at least one spacer element having a corresponding ring-like or ring-shaped basic shape can correspond to the outer dimensions of the substrate element body, so that the at least one spacer element lies flush on the substrate element body. The aforementioned layer or coating of an electrolyte material can be arranged or formed within the inner space defined by the ring-like or ring-shaped basic shape of the at least one spacer element. The at least one spacer element is configured in particular to distance or separate the contact layers of the respective substrate elements from each other so that they cannot make electrical contact.

The electrochromic arrangement can be structurally integrated into an optical channel or tube of the long-range optical arrangement, which typically extends between an eyepiece and an objective lens of the long-range optical device; consequently, the electrochromic arrangement can be arranged or formed in the optical channel or tube of the long-range optical device. In particular, the electrochromic arrangement can be arranged or formed in a section of the optical channel or tube extending between an objective lens and an eyepiece.

The long-range optical device can comprise an optical output device, e.g. in the form of a display, for outputting optical information. The optical information that can be output via the optical output device, i.e. e.g. alphanumeric symbols, graphics, images, videos, etc., can be coupled into the optical channel of the long-range optical device via a coupling device, e.g. formed by or comprising a prism arrangement comprising one or more prisms or via a foil arrangement. The electrochromic arrangement can be directly or indirectly associated with the optical output device so that, for example, the brightness and/or contrast of the optical information that can be output via the optical output device can be specifically changed by means of the electrochromic arrangement.

A further aspect of the invention relates to a method for producing an electrochromic arrangement for a long-range optical device, in particular for producing an electrochromic arrangement according to the embodiment described above, so that all explanations in connection with the electrochromic arrangement according to the embodiment described above apply analogously to the method (and vice versa).

The method comprises at least the steps, which may be performed more than once: a) providing at least one substrate element comprising a substrate element body, the substrate element body having a surface with a first portion and optionally a curved or inclined second portion; and b) applying at least one electrochromic element formed by or comprising an electrochromic material at least on the first portion of the surface of the substrate element body.

In particular, the method comprises at least the following steps, which may be carried out several times: providing at least one substrate element with a substrate element body, the substrate element body having a surface with a first section and optionally a curved or inclined second section; applying an electrically conductive layer or coating to the first and second sections of the surface of the substrate element body; applying at least one electrochromic element formed by or comprising an electrochromic material at least to the electrically conductive layer or coating at least in the region of the first section of the surface of the substrate element body.

As part of the method, it is possible to arrange configured substrate elements lying on top of one another as described above, in particular in such a way that respective second sections of the surface of the respective substrate element bodies are arranged opposite one another, forming a wedge-like or wedge-shaped intermediate space.

The method may further comprise a step of electrically contacting respective second sections with an electrical energy source or supply. For this purpose, the respective second sections can each be contacted with the electrical energy source or supply via at least one electrical contact element, such as a wire, a cable, a contact ring, a stranded wire, etc.

The invention is explained again below with reference to the embodiments shown in the figures. It shows:

FIGS. 1-3 each a schematic representation of a long-range optical device according to an embodiment example;

FIGS. 4-7 each a schematic diagram of an electrochromic arrangement according to an embodiment example;

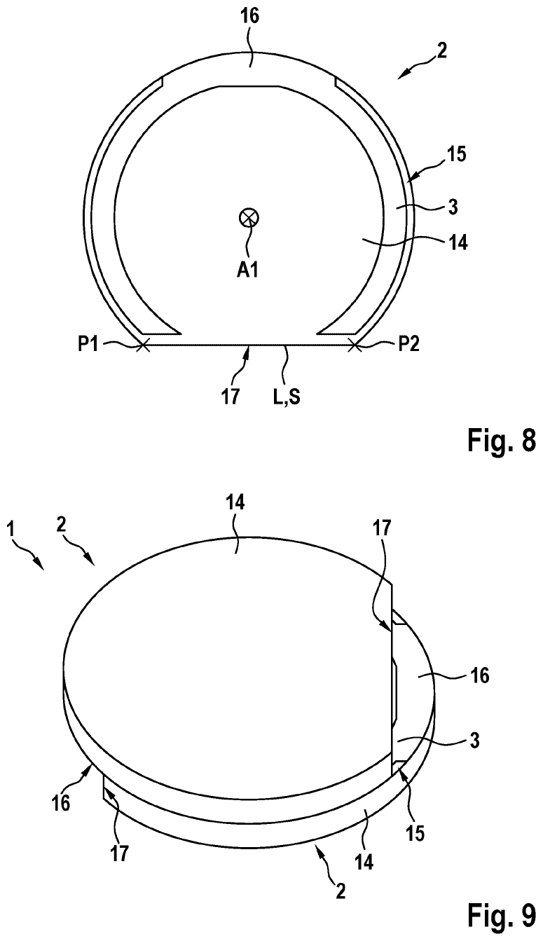

FIG. 8 a schematic representation of a substrate element of an electrochromic arrangement according to an embodiment example;

FIG. 9 a schematic diagram of an electrochromic arrangement according to an embodiment example; and

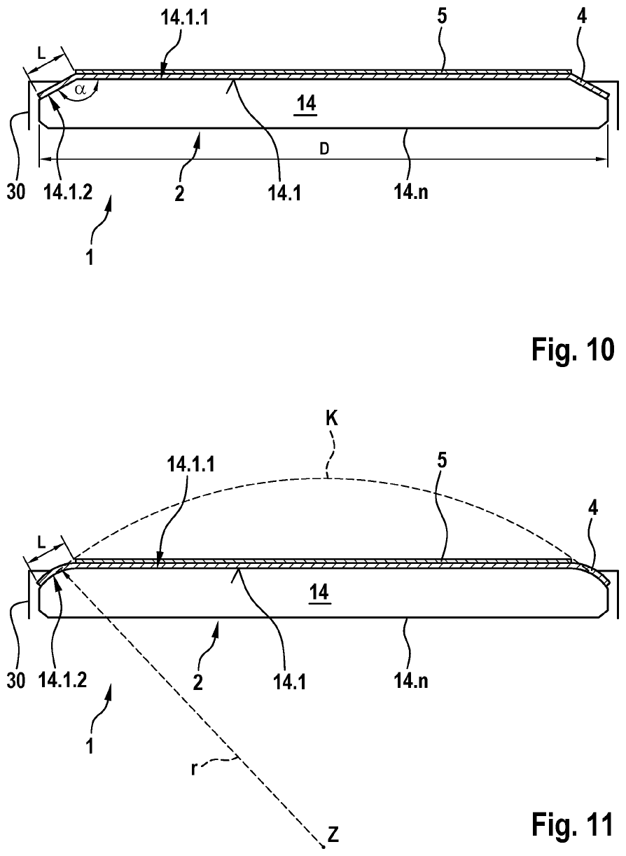

FIGS. 10-15 each a schematic representation of an electrochromic arrangement according to a further embodiment example.

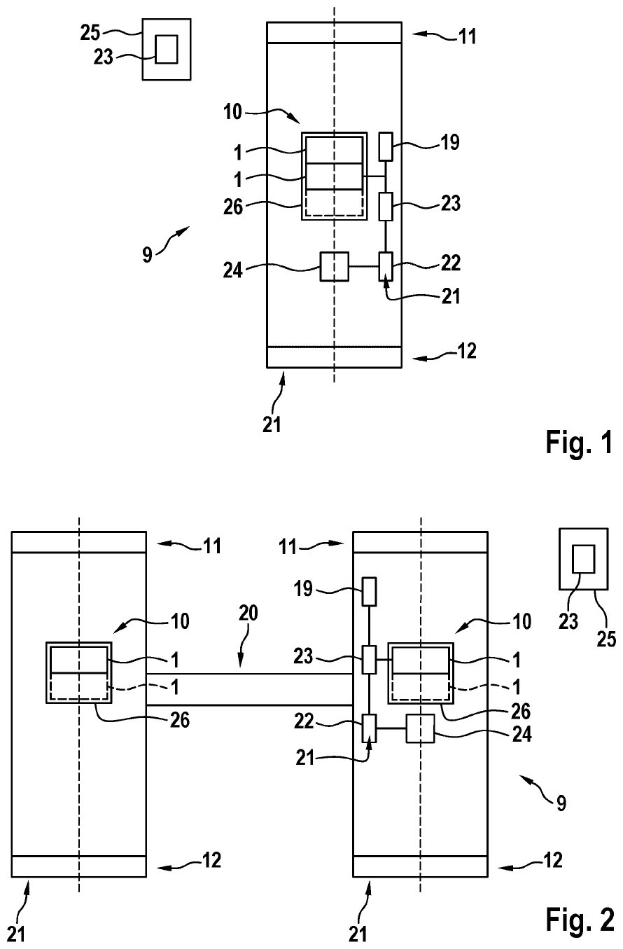

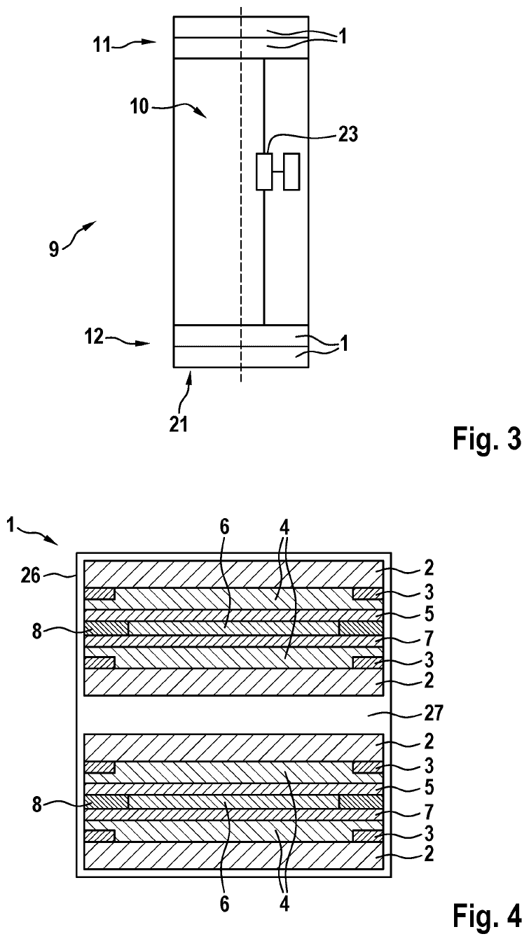

FIGS. 1-3 each show a schematic representation of a long-range optical device 9 according to an embodiment example. FIGS. 1-3 show that the long-range optical device 9 can be configured, for example, as a monocular, telescopic sight, night-vision device or thermal observation or aiming optics (see FIGS. 1, 3) or as binoculars (see FIG. 2).

In all embodiment examples, the long-range optical device 9 thus comprises at least one optical tube 10 defined by an undesignated housing part of the long-range optical device 9. In the embodiment examples shown, the optical tube 10 extends between an objective lens 11 comprising one or more objective lenses (not shown) and an eyepiece 12 comprising one or more eyepiece lenses (not shown). The optical path extending between the objective lens 11 and the eyepiece 12 also defines an optical channel of the long-range optical device 9 indicated by the respective dotted line. In the embodiment example according to FIGS. 1, 3, the long-range optical device 9 comprises one optical tube 10 and thus one optical channel, in the embodiment example according to FIG. 2, the long-range optical device 9 comprises two optical tubes 10 and thus two optical channels. In the embodiment example according to FIG. 2, the optical tubes 10 are connected to each other via a connecting device 20.

In all embodiments, the long-range optical device 9 comprises at least one display region 21 for displaying or viewing optical information. The at least one display region 21 can be formed, for example, by a viewing area or a field of view of an optical channel of the long-range optical device 9. A corresponding viewing area or a corresponding field of view can thus be formed, for example, by an optical channel of the long-range optical device 9, which, as mentioned, extends between the objective lens 11 formed by at least one objective lens and the eyepiece 12 formed by at least one eyepiece lens. Corresponding optical information can therefore be real images, possibly optically magnified, of a target area, target object, etc. observed by means of the long-range optical device.

Alternatively or additionally, the at least one display region 21 can be formed by an electrical or electronic display device 22, such as a display apparatus. Corresponding optical information may thus be electrically or electronically generated optical information, e.g. of a target area, target object, etc., observed by means of the long-range optical device 9. Alternatively or additionally, the corresponding optical information may be alphanumeric and/or graphic information, such as symbols, graphics, images, videos, etc., which have been generated, for example, by a hardware and/or software-implemented control device 23 associated with a corresponding electrical or electronic display device 22.

The optical information output by a corresponding electrical or electronic display device 21 can be coupled into the or an optical channel of the long-range optical device 9 via a coupling device 24, if necessary for superimposed display with a real image, as shown in the Figs. as an example. A corresponding coupling device 24 can, for example, be formed by or comprise a prism arrangement comprising one or more prisms or via a foil arrangement.

It can be seen from Fig. that the long-range optical devices 9 each comprise at least two electrochromic arrangements 1 associated with the at least one display region 21.

As can be seen from FIGS. 4-7, each of the electrochromic arrangements 1 comprises at least one electrochromic element 5, 6 arranged or formed between two electrically conductive elements arranged or formed on respective substrate elements 2 in the form of contact layers 3, e.g. made of a metal such as copper. A corresponding electrochromic element may be formed by or comprise an electrochromic material, for example. It can be seen that each electrochromic element in Fig. is formed by a first layer 5 made of an electrochromic material, a second layer 6 made of an electrochromic material serving as an ion storage layer, which can be referred to as a counter electrode, and a layer 7 arranged or formed between the layers 5, 6 and made of an electrolyte material, e.g. in gel form, which is permeable to ions. On the substrate elements 2 there is also a transparent, electrically conductive layer 4 made of a transparent, electrically conductive material, such as ITO, at least on the surfaces facing the respective electrochromic elements (see layers 5-7). Spacer elements made of an electrically insulating material, such as plastic, are shown with reference sign 8.

Each of the at least two electrochromic arrangements 1 can be transferred into one or more operating states in order to change the brightness and/or contrast of respective optical information. Each of the at least two electrochromic arrangements 1 is thus configured to adjust or change the optical properties, i.e. in particular the brightness and/or color and/or contrast, of respective optical information. Changes to the optical properties of respective optical information are made by transferring the respective electrochromic arrangements 1 into respective operating states of the respective electrochromic arrangements 1; consequently, different operating states of the respective electrochromic arrangements 1 can be correlated with different optical properties of respective optical information.

The long-range optical devices 9 shown in the Figures are thus characterized by at least two electrochromic arrangements 1 associated with the at least one display region 21, which can each be transferred into one or more operating states in order to change the optical properties, i.e. in particular the brightness and/or the chromaticity and/or the contrast, of respective optical information. This opens up additional freedom in connection with the possibilities for changing or adjusting the optical properties of the at least one display region 21. This results in particular from the fact that certain optical properties of respective optical information can be obtained by transferring the at least two electrochromic arrangements 1 in each case specifically into certain operating states, whereby the at least two electrochromic arrangements 1 each have a certain transmittance (optical transmission) for light of a certain wavelength or of a certain wavelength range and associated therewith, a specific brightness, color, contrast, etc., whereby, in turn, a resulting transmittance for light of a specific wavelength or a specific wavelength range and, associated therewith, a resulting brightness, color, contrast, etc. of the at least two electrochromic arrangements 1 can be realized.

As can be seen from the embodiment examples according to FIGS. 1, 2, the at least two electrochromic arrangements 1 or at least two electrochromic arrangements 1 can be arranged or formed in a series connection, so that the at least two electrochromic arrangements 1 are arranged or formed directly or indirectly, i.e. with the interposition of at least one other optical element, one behind the other in an optical path, i.e. in particular an optical channel, of the respective long-range optical device 1. Alternatively or additionally, the at least two electrochromic arrangements 1 or at least two electrochromic arrangements 1 can be arranged or formed in a parallel circuit, so that the at least two electrochromic arrangements 1 are arranged or formed next to each other in an optical path, i.e. in particular an optical channel, or in each case in an optical path, i.e. in particular an optical channel, of the respective long-range optical device 1. Consequently, in the case of a long-range optical device 1 with several optical paths or channels, as shown in FIG. 2, at least one electrochromic arrangement 1 can be arranged or formed in each optical channel or path.

For transferring the at least two electrochromic arrangements 1 into respective operating states, the long-range optical device 9 comprises a control device 23 which is associated with the at least two electrochromic arrangements 1 and implemented in hardware and/or software and which is configured to generate control information for transferring the at least two electrochromic arrangements 1 into one or more operating states. The control device 23 can be configured to generate control information for transferring the at least two electrochromic arrangements 1 into respective operating states. Corresponding control information can, for example, be or be generated on the basis of information or signals generated by user-side inputs and/or information or signals generated by detection or sensor devices (not shown), for example for detecting the optical properties of an environment around the long-range optical device 9.

FIGS. 1, 2 show that the control device 23 can be arranged or formed on or in a housing part of the long-range optical device 9. Alternatively or additionally, the or a control device 23 can be arranged or formed in a mobile terminal 25, such as a laptop, smartphone, smart glasses, tablet, etc., or at least one other long-range optical device, such as a target optic, a target range finder, etc., which communicates with the long-range optical device 9 via a wired or wireless data connection. Wireless data connections can be or are implemented via standards for wireless data transmission, such as Bluetooth®.

The transfer of the at least two electrochromic arrangements 1 into respective operating states can be carried out, for example, by applying an electrical voltage or an electrical current to the respective electrochromic arrangement 1. It is possible that by applying electrical voltages or electrical currents of different levels, which may vary over time, to a respective electrochromic arrangement 1, different operating states of the respective electrochromic arrangement 1 can be realized, which are accompanied by different, i.e. in particular differently pronounced, changes in the optical properties of respective optical information. The level of the electrical voltages or electrical currents that can be applied or applied to the respective electrochromic arrangements 1, possibly varying over time, can be controlled or regulated via the control device 23 as part of a transfer of the respective electrochromic arrangements 1 into respective operating states.

In order to be able to apply electrical voltages or electrical currents to the respective electrochromic arrangements 1, the long-range optical device 9 can have at least one electrical energy supply device 19, e.g. in the form of an electrical energy storage device, such as a wired or wirelessly chargeable battery. A corresponding electrical energy supply device 19 can be structurally arranged or formed on or in a housing part of the long-range optical device 9.

If the long-range optical device 9 comprises several display regions 21, such as in a configuration with a first display region formed by an optical channel for a real image and a second display region formed by an electrical or electronic display device 22 for an electrically or electronically generated image, at least one electrochromic arrangement 1 can be associated with each display region 21. Alternatively, the at least two electrochromic arrangements 1 can be associated with only one (single) display region 21.

As indicated in FIGS. 1-6 by the frame 26 surrounding the respective electrochromic arrangements 1, one or more electrochromic arrangements 1 can form an assembly which is structurally arranged or formed within an optical channel of the long-range optical device 9. Alternatively or additionally, one or more electrochromic arrangements 1 can form an assembly which is structurally arranged or formed outside the respective optical channel of the long-range optical device 9.

A corresponding frame 26 can represent a modular or modular-shaped assembly, which in turn can be formed, for example, by a modular or modular-shaped housing device or comprise such a housing device, which has a receiving space within which the at least two electrochromic arrangements 1 can be arranged or formed. A corresponding housing device can comprise one or more fastening interfaces (not shown), via which the housing device can be fastened in a defined orientation and/or position on or in the long-range optical device 9. Corresponding fastening interfaces can, for example, be mechanical fastening interfaces which enable form-fit and/or force-fit fastening of a corresponding housing device to or in the long-range optical device 9, i.e. in particular to or in a housing part of the long-range optical device 9. Alternatively or additionally, it is of course conceivable to attach the housing device to or in the long-range optical device 9 by means of material bonding, i.e. e.g. adhesive or welded attachment.

The at least two electrochromic arrangements 1 can be transferred into one or more respective operating states depending on or independently of one another and can thus be transferred into respective operating states depending on or independently of one another. The at least two electrochromic arrangements 1 can thus be put into operation and/or operated depending on or independently of one another. An interdependent transfer of the at least two electrochromic arrangements 1 into respective operating states can mean, for example, that in a case in which a first electrochromic arrangement 1 is transferred into an operating state or is operated in an operating state in which the transmittance for light of a specific wavelength or of a specific wavelength range is increased or decreased by a specific value, a second electrochromic arrangement 1 is operated in response to the change in the transmittance for light of a specific wavelength or of a specific wavelength range of the first electrochromic arrangement 1 and thus, depending thereon, is transferred to an operating state or is operated in an operating state in which the transmittance for light of a specific wavelength or of a specific wavelength range is likewise increased or decreased by the or another specific value. A mutually independent transfer of the at least two electrochromic arrangements 1 into respective operating states can mean, for example, that in a case in which a first electrochromic arrangement 1 is transferred into an operating state or operated in an operating state in which the transmittance for light of a specific wavelength or of a specific wavelength range is increased or decreased by a specific value, but a second electrochromic arrangement 1, in response to the change in the transmittance for light of a specific wavelength or of a specific wavelength range of the first electrochromic arrangement 1, is independently thereof transferred into an operating state or operated in an operating state in which the transmittance for light of a specific wavelength or of a specific wavelength range is likewise increased or decreased by the or another specific value.

The transfer of the at least two electrochromic arrangements 1 into respective operating states can be realized by a targeted adjustment of the optical properties of the at least one display region 21 for specific application areas, which can be characterized, for example, by a special environment in which the long-range optical device 9 is used, for example, for observing a target area, target object, etc. For example, for an application of the long-range optical device 9 in an area of high brightness, such as a snowy area, a desert, etc., and/or in an area of certain colorfulness, such as in a forest, on water, etc., a special setting of the optical properties of the at least one display region 21 can be made in each case, which can be automated or controlled automatically via the control device 23. In this way, for example, a high ambient brightness can be reduced and/or a low ambient contrast can be increased. In an analogous manner, alternatively or additionally, for an application of the long-range optical device 9 at a particular time of day, month or year, a particular setting of the optical properties of the at least one display region 21 can be made, which may be controlled in an automatable or automated manner via the control device 23.

By transferring the at least two electrochromic arrangements 1 into respective operating states, a blocking functionality of the long-range optical device 9 can be implemented, which includes a temporary transfer of the electrochromic arrangements 1 into a respective operating state in which the resulting transmittance for light of a certain wavelength or a certain wavelength range is so low that the optical information cannot be displayed or viewed or cannot be displayed or viewed to the desired extent or in the desired manner. This can be realized, for example, by selectively darkening, coloring, etc. the at least one display region 21 or the optical information. A corresponding blocking functionality can therefore include the implementation of a blocking mode in which the resulting transmittance for light of a certain wavelength or a certain wavelength range is so low that the optical information cannot be displayed or viewed or cannot be displayed or viewed to the desired extent or in the desired manner. The cancellation of a blocking mode can be realized, e.g. implemented by the control device 23, by authentication or identification of a specific user, e.g. by password entry, user identification, etc. In a similar way, the deactivation of a blocking mode can alternatively or additionally be carried out on an external terminal device, such as a laptop, smartphone, smart glasses, tablet, etc., or at least one other long-range optical device, such as a target optic, a target range finder, etc.

As already mentioned and shown in FIGS. 1, 2, the at least two electrochromic arrangements 1 can be arranged or formed in an optical channel of a long-range optical device 9, which, as also already mentioned and shown in FIGS. 1, 2, extends between an objective lens 11 and an eyepiece 12 of the long-range optical device 9. As can be seen from FIG. 3, the at least two electrochromic arrangements 1 can be associated with, for example, the objective lens 11, the eyepiece 12 or another optical assembly (not shown) comprising one or more optical elements arranged or formed within the optical channel, such as a divider cube assembly (if present). In this way, the transmittance of the objective, the eyepiece or a corresponding optical assembly for light of a specific wavelength or a specific wavelength range can be changed or adjusted. In the embodiment example according to FIG. 3, it is shown in particular that the at least two electrochromic arrangements 1 can be integrated directly into an objective lens 11 and/or eyepiece 12 of the long-range optical device 9. Consequently, in particular the substrate elements 2 of the at least two electrochromic arrangements 1 can be configured and/or serve as lens elements of the objective lens 11 and/or the eyepiece 12 of the long-range optical device 9. One or more corresponding lens elements and thus one or more corresponding substrate elements 2 may be curved or domed.

For the embodiment example shown in FIG. 2, in which the long-range optical device 9 has two optical channels, at least one first electrochromic arrangement 1 can be arranged or formed in a first optical channel of the long-range optical device 9 and at least one second electrochromic arrangement 1 can be arranged or formed in a second optical channel of the long-range optical device 9. The optical properties of the at least two optical channels, i.e. in particular the transmittance for light of a specific wavelength or a specific wavelength range, can thus be changed or adjusted by transferring the electrochromic arrangements 1 arranged or formed in these channels, depending on or independently of one another. As mentioned and shown as an example in FIG. 2, at least two electrochromic arrangements 1 can also be arranged or formed in each optical channel.

Specific exemplary arrangement and configuration options for the at least two electrochromic arrangements 1 are explained below with reference to FIGS. 4-7.

The embodiment example according to FIG. 4 shows an example configuration with two electrochromic arrangements 1.

In the embodiment example, each electrochromic arrangement 1 comprises, from top to bottom, a first substrate element 2 made of a transparent material, such as glass or plastic, on which a contact layer 3 made of an electrically conductive metal, such as copper, which serves to contact the electrochromic materials mentioned below with an external voltage supply, and a transparent, electrically conductive layer 4 made of a transparent, electrically conductive material, such as ITO, are arranged or formed. This is followed by a first layer 5 made of an electrochromic material, which can be referred to as the working electrode, a layer 6 made of an ion-permeable electrolyte material, e.g. in gel form, and a second layer 7 made of an electrochromic material serving as an ion storage layer, which can be referred to as the counter electrode. The layer structure is then repeated when the second layer 7 made of an electrochromic material is followed by a contact layer 3 made of an electrically conductive metal, such as copper, which serves to contact the aforementioned electrochromic materials with an external voltage supply, and a transparent, electrically conductive layer 4 made of a transparent, electrically conductive material, such as ITO, and a second substrate element 2. Spacer elements made of an electrically insulating material, such as plastic, are shown with reference sign 8.

In the embodiment example according to FIG. 4, a gap 27 and thus, for example, an air space is formed between the two electrochromic arrangements 1, so that an antireflection coating can be applied to the surface of the second or lower substrate element 2 of the first or upper electrochromic arrangement 1 facing the first or upper substrate element 2 of the second or lower electrochromic arrangement 1. Alternatively or additionally, an anti-reflective coating can be applied to the surface of the first or upper substrate element 2 of the second or lower electrochromic arrangement 1 facing the second or lower substrate element 2 of the first or upper electrochromic arrangement 1.

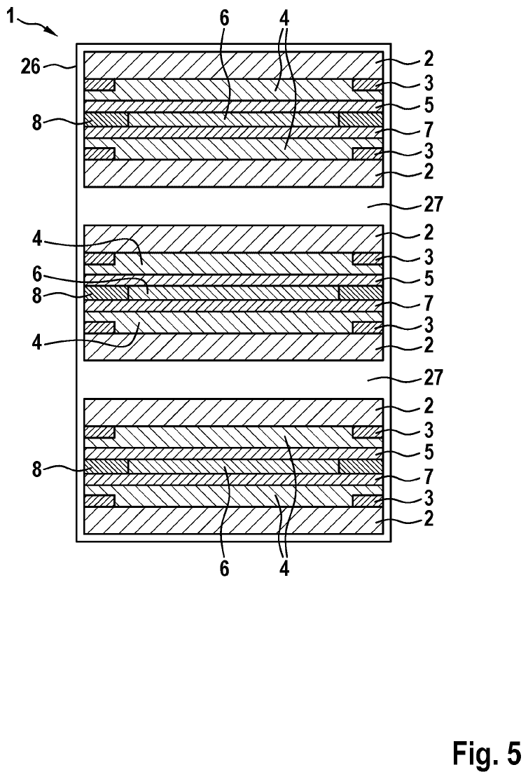

The embodiment example according to FIG. 5 differs from the embodiment example according to FIG. 4 in that here not two electrochromic arrangements 1, but three electrochromic arrangements 1 are arranged or formed in series. All explanations in connection with the embodiment example according to FIG. 4 apply analogously. The same applies to embodiments with more than three electrochromic arrangements 1 connected in series.

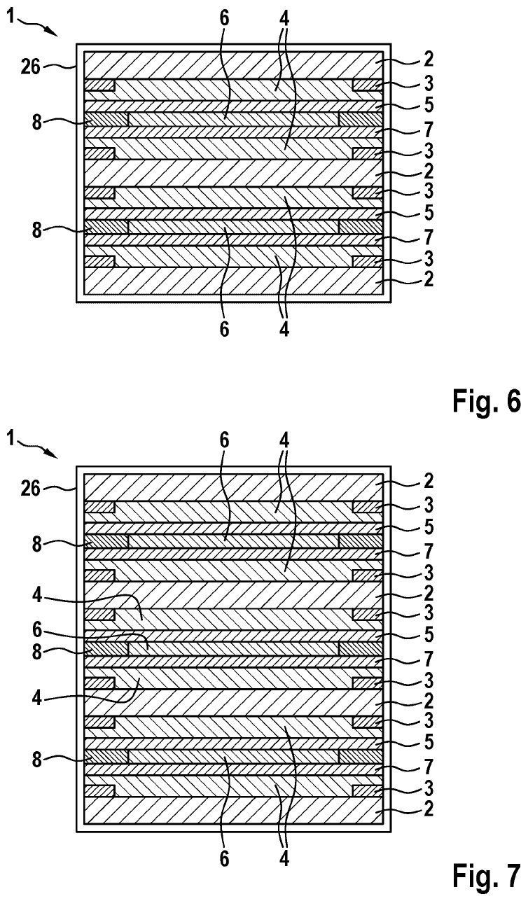

The embodiment example according to FIG. 6 is fundamentally based on the embodiment example according to FIG. 4, but differs from it in that there is no gap space 27 and thus no air gap between the two electrochromic arrangements 1, because the second or lower substrate element 2 of the first or upper electrochromic arrangement equally forms the first or upper substrate element 2 of the second or lower electrochromic arrangement 1. Consequently, this substrate element associated with both electrochromic arrangements 1 has two contact layers 3 and two electrically conductive layers 4, with the contact layer 3 arranged or formed on a first surface of the substrate element 2 and the electrically conductive layer 4 being associated with the first or upper electrochromic arrangement 1, and the contact layer 3 arranged or formed on the opposite second surface of the substrate element 2 and the electrically conductive layer 4 being associated with the second or lower electrochromic arrangement 1.

The embodiment example according to FIG. 7 differs from the embodiment example according to FIG. 6 in that here not two electrochromic arrangements 1, but three electrochromic arrangements 1 are arranged or formed in series. All explanations in connection with the embodiment example according to FIG. 6 apply analogously. The same applies to embodiments with more than three electrochromic arrangements 1 connected in series.

Based on the embodiment examples according to FIGS. 6 and 7, it can be seen that two electrically conductive elements can be arranged or formed on at least one substrate element 2, in particular on different surfaces, i.e. e.g. an upper side and a lower side, of the substrate element 2, wherein a first electrically conductive element arranged or formed on a first surface, i.e. e.g. a first electrically conductive element arranged or formed on a first surface, e.g. a top side, of the substrate element 2 is associated with a first electrochromic arrangement 1, and a second electrically conductive element arranged or formed on a second surface, e.g. a bottom side, of the substrate element is associated with a second electrochromic arrangement 1.

In all the exemplary embodiments, a first electrochromic arrangement 1 can be associated with an optical channel of the long-range optical device 9 in order to change or adjust the brightness and/or the color and/or the contrast, i.e. in general the transmission of light of a certain wavelength or a certain wavelength range, of the optical information that can be viewed via the optical channel, i.e. for example of a real image, and at least one second electrochromic arrangement 1 of an electronic display device 22 (if present), such as a display apparatus, can be associated with the long-range optical device 9, in order to change or adjust the brightness and/or the colorfulness and/or the contrast, i.e. in general the transmission of light of a certain wavelength or of a certain wavelength range, of the optical information generated by means of the electronic display device 22. As mentioned, the optical information generated by the electrical or electronic display device 22 may be couplable or coupled in via an optical coupling device 24, in particular for superposition with the optical information viewable in the optical channel.

For all embodiments, it further applies that a first electrochromic arrangement 1 can be configured in respective one or more operating states for adjusting a defined brightness and/or a defined colorfulness and/or a defined contrast of respective optical information in a first brightness and/or colorfulness and/or contrast range, and a second electrochromic arrangement 1 can be configured in respective one or more operating states for adjusting a defined brightness and/or a defined colorfulness and/or a defined contrast of respective optical information in a second brightness and/or colorfulness and/or contrast range. The second brightness and/or chromaticity and/or contrast range can be the same as or different from the first brightness and/or chromaticity and/or contrast range (and vice versa). The chemical and/or physical properties of the electrochromic elements of respective electrochromic arrangements 1 for the adjustment options of a defined brightness and/or a defined chromaticity and/or a defined contrast, i.e. generally the transmittance for light of a specific wavelength or a specific wavelength range, can be the same, so that different electrochromic arrangements 1 can realize, for example, the same brightness and/or chromaticity and/or contrast ranges due to electrochromic elements configured identically with respect to their chemical and/or physical properties. In this way, certain ranges of brightness and/or color and/or contrast can be intensified. Alternatively, the chemical and/or physical properties of the electrochromic elements of respective electrochromic arrangements 1 used for the adjustment options of a defined brightness and/or a defined chromaticity and/or a defined contrast, i.e. generally the transmittance for light of a specific wavelength or a specific wavelength range, can be different, so that different electrochromic arrangements 1 can realize, for example, different brightness and/or chromaticity and/or contrast ranges due to electrochromic elements configured differently with respect to their chemical and/or physical properties.

Accordingly, it applies to all embodiments that a first electrochromic arrangement 1 can be configured in respective one or more operating states for adjusting a defined chromaticity of respective optical information in a first wavelength range, and a second electrochromic arrangement 1 can be configured in respective one or more operating states for adjusting a defined chromaticity of respective optical information in a second wavelength range. The second chromaticity range or the second color associated therewith can be the same or different from the first chromaticity range or the first color associated therewith (and vice versa). In the case of different chromaticity ranges or colors, these can be complementary, for example. Here, too, the chemical and/or physical properties of the electrochromic elements of respective electrochromic arrangements 1 that are responsible for the adjustment possibilities of a defined chromaticity or color, i.e. generally the transmittance of light of a certain wavelength or a certain wavelength range, can be the same, so that different electrochromic arrangements 1 can realize, for example, the same chromaticity ranges or color ranges or colors due to electrochromic elements that are configured identically with respect to their chemical and/or physical properties. In this way, certain chromaticity ranges or color ranges or colors can be intensified. Alternatively, the chemical and/or physical properties of the electrochromic elements of respective electrochromic arrangements 1 that are responsible for the adjustment possibilities of a defined chromaticity or color, i.e. generally the transmittance for light of a certain wavelength or a certain wavelength range, can be different, so that different electrochromic arrangements 1 can realize, for example, different chromaticity ranges or color ranges or colors due to electrochromic elements configured differently with respect to their chemical and/or physical properties. As mentioned, the second chromaticity range or color range can be different from the first chromaticity range or color range, whereby the second chromaticity range or color range can be a complementary chromaticity range or color range to the first chromaticity range or color range. This can be useful for hunting applications, for example, because animals can be better distinguished from plants.

As already explained, each electrochromic arrangement 1 comprises corresponding contact layers 3 made of an electrically conductive material for making electrical contact with the electrochromic element or elements typically present as a layer or coating 5, 7 made of an electrochromic material, i.e. in particular for applying an electrical voltage or an electrical current. An embodiment example of a particular configuration of the contact layers 3 is explained in more detail below with reference to FIGS. 8 and 9:

FIG. 8 shows an exemplary top view of the upper or lower side of a substrate element 2 of an electrochromic arrangement 1 according to an embodiment example, whereby the following explanations in connection with the embodiment example shown in FIG. 8 can apply analogously to all substrate elements 2 of each electrochromic arrangement 1.

The substrate element 2 consists of a substrate element body 14, which in the embodiment example has an exemplary circular disk-like or circular basic shape. In principle, the substrate element body 14 has a basic shape which can be integrated into an optical tube 10 of a long-range optical device 9; consequently, shape-determining geometric-constructive parameters, such as dimensions, of the substrate element body 14 are selected with regard to the installation space available in a long-range optical device 9, i.e. in particular in the optical tube 10, for integration as intended.

As mentioned, the contact layer 3 formed from an electrically conductive material, such as a metal, in particular a precious metal, such as gold, or a semi-precious metal, such as copper, is arranged or formed on the upper or lower side of the substrate element body 14, which forms the main plane of extension of the substrate element 2. The contact layer 3 is typically applied to the upper or lower surface of the substrate element body 14 by a chemical and/or physical application process, in particular a chemical and/or physical deposition process, further in particular a chemical and/or physical vapor deposition process. The layer thickness of the contact layer 3 can, for example, be in a range between 10 nm and 500 nm, in particular in a range between 10 nm and 450 nm, further in particular in a range between 10 and 400 nm, further in particular in a range between 10 nm and 350 nm, further in particular in a range between 10 nm and 300 nm, further in particular in a range between 10 nm and 250 nm, further in particular in a range between 10 nm and 200 nm, further in particular in a range between 10 and 150 nm, further in particular in a range between 10 and 100 nm, further in particular in a range between 10 and 50 nm.

It is evident that the contact layer 3 extends in a ring-like or ring-shaped manner, i.e. in particular in a ring-segment-like or ring-shaped manner, around the edge or along the edge of the substrate element body 14, which has a circular disk-like or circular basic shape. The contact layer 3 is thus configured as an electrically conductive layer extending at least in sections around the edge or along the edge of the substrate element body 14. In the embodiment example according to FIG. 8, the contact layer 3 is shown as a continuous layer; in principle, quasi-continuous or discontinuous contact layers 3 are also conceivable; consequently, the contact layer 3 can generally be a continuous, quasi-continuous or discontinuous electrically conductive layer running around the edge or along the edge of the substrate element body 14.

The substrate element body 14 is therefore not provided with the contact layer 3 over the entire surface in the area of its upper or lower side, but only in a section of the upper or lower side that runs around the edge. This results not only in advantages with regard to reliable electrical contacting of the electrochromic arrangement 1 with an electrical power supply, such as a battery integrated in a long-range optical device, but also with regard to the application of an electrical voltage to the electrochromic elements, which occurs at least intermittently during operation of the electrochromic arrangement 1, when these are contacted in a ring-like or ring-shaped manner.—This leads to a surprisingly rapid and uniform change in the optical properties, i.e. in particular the transmission, of the electrochromic arrangement 1, particularly in contrast to contacting only at a point. The described arrangement or design of the electrically conductive layer also enables a change in brightness or contrast largely circumferentially from “outside to inside” and excludes phenomena known from the prior art, such as coloration in the manner of a stage curtain. Furthermore, there are advantages in terms of production technology, for example, as the substrate element 2 does not have to be provided with a contact layer 3 over the entire surface in the area of the top or underside of the substrate element body, but only around the edge.

As mentioned, the contact layer 3 extends in a ring-like or -shaped manner, i.e. in particular in a ring-segment-like or -shaped manner, i.e. with a ring-like or -shaped or a ring-segment-like or -shaped basic shape, at least in sections around the edge or along the edge of the substrate element body 14. In the embodiment example shown in FIG. 8, the contact layer 3 extends around at least 50% of the edge circumferentially around or along the edge of the substrate element body 14. The more completely the contact layer 3 extends around the edge or along the edge of the substrate element body 14, the faster or more uniformly a change in the optical properties, i.e. in particular the transmission, of the electrochromic arrangement 1 can be brought about.

FIG. 8 also shows that there may be a defined free space 15 between the contact layer 3 and the edge of the substrate element body 14, at least in sections, in which the contact layer 3 does not extend. Consequently, the contact layer 3 does not have to extend completely to the edge of the substrate element body 14 in terms of its radial extension (with respect to an axis of symmetry or central axis A1 of the substrate element body 14), at least in sections, but there can be a defined distance, e.g. of 0.5 mm, between the outer circumference of the contact layer 3 and the actual edge of the upper or lower side of the substrate element body 14.

FIG. 8 also shows that the contact layer 3 can comprise a contact section 16 that can be contacted by an electrical contact element, such as a wire, a stranded wire, a cable, a spring contact, a pin contact, etc., that can be connected or connected to the electrical voltage or power supply.

FIG. 8 also shows that the contact section 16, for example to ensure reliable contacting with a corresponding electrical contact element, has different dimensions than the other regions of the contact layer 3 with regard to its radial extension in the direction of the edge of the upper or lower side of the substrate element body 14. The contact section 16 can thus be formed by or represent a radial extension of the contact layer 3 (compared to the other areas of the contact layer 3), which extends circumferentially around a certain area of the edge of the substrate element body, i.e. for example by at least 10%, around or along the edge of the substrate element body 14. The contact section 16 can be applied directly to the upper or lower side of the substrate element body 14; in the area of the contact section 16, therefore, there does not have to be a corresponding transparent, electrically conductive layer or coating.

FIG. 8 further shows that the edge of the substrate element body 14 can have a flattening 17. In particular, the flattening 17 can be defined by a straight line L or a corresponding secant S running through two points P1, P2 on the edge of the substrate element body 14 forming the outer circumference of the substrate element body 14. The shape of the substrate element body 14 need not therefore be a complete circular disk since the edge of the substrate element body 14 can have a corresponding flattening 17. The flattening 17 can likewise simplify the structural integration of the electrochromic arrangement into a long-range optical device 9, for example as the flattening 17 can be used to realize an anti-rotation lock of the electrochromic arrangement 1 in an optical tube 10 of the long-range optical device 9.

Similarly, the flattened section 17 can form a functionalized interface of the electrochromic arrangement 1 when, as can be seen further in connection with the embodiment example according to FIG. 9, a special electrical contacting option of the electrochromic arrangement 1 with an electrical power supply can be implemented in this way. This applies in particular if, as shown in FIG. 8, the contact section 16 is arranged or formed opposite the flattened section 17. The contact section 16 and the flattening 17 can therefore be arranged or formed (essentially) offset by 180° in the circumferential direction with respect to the circular disk-like or circular basic shape of the substrate element body 14. In the top view of the upper or lower side of the substrate element body 14 shown in FIG. 8, the contact section 16 is thus arranged or formed at the top and the flattened portion 17 is arranged or formed opposite at the bottom.

Based on the embodiment example according to FIG. 9, it can be seen that the electrochromic arrangement 1 has two correspondingly configured substrate elements 2, each of which has a substrate element body 14 with a corresponding flattened portion 17 and a contact portion 16 arranged or formed opposite the flattened portion 17. The substrate element bodies 14 of the first substrate element 2 and the second substrate element 2 are arranged one above the other, with their contact layers 3 facing each other, but cannot make electrical contact with each other in order to avoid short circuits. The respective contact layers 3 can lie on top of each other in such a way that they can complement each other to form a closed ring; consequently, the contact layer 3 arranged or formed on the substrate element body 14 of a first substrate element 2 (e.g. the upper substrate element in FIG. 9) can (also) extend in the circumferential direction in an area in which no contact layer 3 extends on the substrate element body 14 of a second substrate element 2 (e.g. the lower substrate element in FIG. 9). It is also evident that the superimposed arrangement of the substrate elements 2 is selected such that their respective contact sections 16 are at least partially exposed, so that the electrochromic arrangement 1 can be contacted with the electrical power supply both via the contact section 16 of the first substrate element 2 and via the contact section 16 of the second substrate element 2. A first electrical contact element can connect the contact section 16 of the contact layer 3 of a first substrate element 2 (e.g. the upper substrate element 2 in FIG. 9) to the electrical power supply and a second electrical contact element can connect the contact section 16 of the contact layer 3 of a second substrate element 2 (e.g. the lower substrate element in FIG. 9) to the electrical power supply.

FIGS. 10-15 each show a schematic diagram of an electrochromic arrangement 1 according to a further embodiment example. This electrochromic arrangement 1 can also form a component of the long-range optical device 9.

The electrochromic arrangement 1 is an assembly, i.e. in particular an electrochromic assembly, which can be structurally integrated into a long-range optical device 9. In particular, the electrochromic arrangement 1 is an assembly, i.e. in particular an electrochromic assembly, which can be structurally integrated into an optical channel of a long-range optical device 9, in particular into an optical channel extending within an optical tube 10 of the long-range optical device 9 between an objective lens 11 and an eyepiece 12. As a component of a corresponding long-range optical device 9, the electrochromic arrangement 1 is therefore an assembly, i.e. in particular an electrochromic assembly, which is integrated into a corresponding optical channel of the long-range optical device 9.

The electrochromic arrangement 1 comprises at least one substrate element 2 with a substrate element body 14. The substrate element body 14 has a basic shape which can be integrated into an optical tube of a long-range optical device 9. Consequently, shape-determining geometric-constructive parameters, such as the dimensions, shape, etc., of the substrate element body 14 are typically selected with regard to the installation space available in a long-range optical device 9 for the intended integration of the electrochromic arrangement 1.

The substrate element 2 or the substrate element body 14 is typically formed from a transparent material. Specifically, the substrate element 2 or the substrate element body 14 can therefore be formed, for example, from glass, in particular sapphire glass, silicate glass, further in particular borosilicate glass, or from a (transparent) plastic, in particular polycarbonate, polymethyl methacrylate. In this context, it is also conceivable for the substrate element 2 or the substrate element body 14 to be made of a transparent film material or a transparent film.

In the embodiment example, the substrate element body 14 has one or more surfaces 14.1-14.n. Based on the embodiment examples according to FIGS. 10, 11, it can be seen that at least one surface 14.1 can be planar. In these embodiments, the substrate element body 14 thus has at least one planar base section formed by a planar surface 14.1 of the substrate element body 14. Depending on the specific embodiment of the substrate element body 14, the planar base section can be arranged or formed, for example, parallel or at an angle to at least one other surface of the substrate element body 14. In the embodiment examples shown in FIGS. 10, 11, the planar base section exemplarily forms a part of the upper side of the substrate element body 14 and is therefore arranged parallel to a surface forming a lower side of the substrate element body 14.

In the embodiments shown in FIGS. 10, 11, the substrate element body 14 has a circular disk-like or circular basic shape. The substrate element 2 or the substrate element body 14 can therefore be a circular disk-like or circular disk-shaped component. This is a comparatively compactly configured embodiment with regard to its spatial volume. When the substrate element 2 or the substrate element body 14 is configured as a (circular) disk-like or disk-shaped component, a corresponding planar base section can be formed, for example, by an upper side or in the region of an upper side of the substrate element body 14, as can be seen from FIGS. 10, 11.

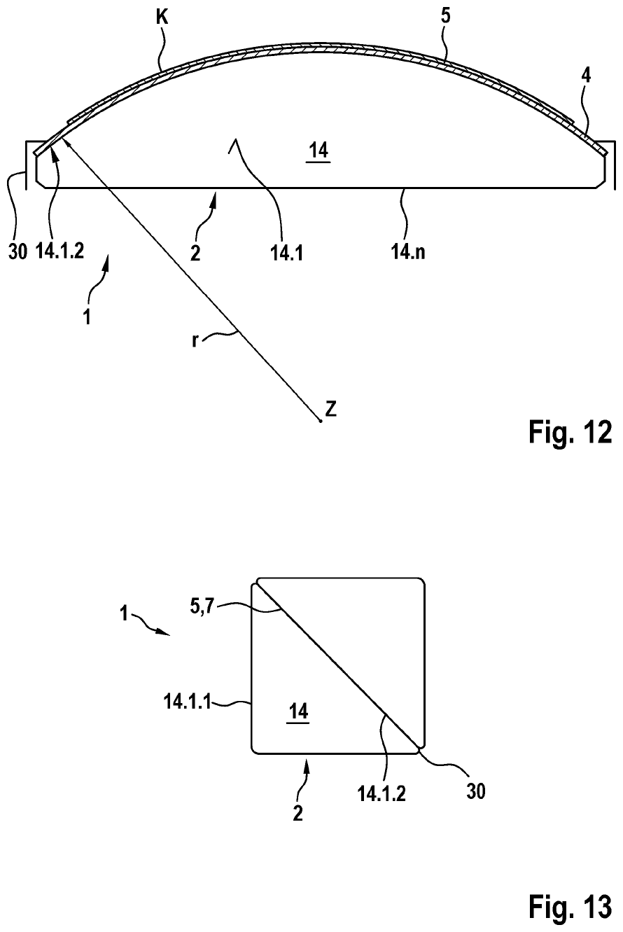

In the embodiment example shown in FIG. 12, in contrast to the embodiment examples shown in FIGS. 10, 11, the substrate element body 14 does not have a flat base section in the region of its upper side, but is (completely) curved in the region of its upper side. The substrate element body 14 can therefore have a lens geometry, for example. Similarly, an embodiment of the substrate element body 14 with an inclined upper side would also be conceivable.

In the embodiment example shown in FIG. 13, the substrate element body 14 has a polygonal basic shape. The substrate element 2 or the substrate element body 14 can therefore be a polygonal or polygonal component. In particular, the substrate element 2 or the substrate element body 14 can be a prism, in particular a prism forming a component of an optical beam splitter, such as a beam splitter cube. This is a highly integrated embodiment configured with regard to the integration of various optical functions. When the substrate element 2 or the substrate element body 14 is configured as a polygonal or polygonal component, a corresponding planar base section can be formed, for example, by an outer surface or in the area of an outer surface of the substrate element body 14, as shown in FIG. 13.

In the embodiments according to FIGS. 10, 11, an electrochromic element formed of or comprising at least one electrochromic material, which can be formed, for example, by the layer 5, is arranged or formed on the surface 14.1 of the substrate element body 14—the surface 14.1 is, as mentioned, an outer surface of the substrate element body 14 forming the upper side of the substrate element body 14 as an example. This surface 14.1 of the substrate element body 14 is the aforementioned planar surface or the surface 14.1 of the substrate element body 14 has the aforementioned planar base section. The same applies to the embodiment example according to FIG. 12.

The electrochromic material can, for example, change its transmission, e.g. by increasing or decreasing its color or color intensity, when an electrical voltage or an electrical current is applied. The electrochromic material can therefore be regarded as an electrically switchable electrochromic material, for example. Specifically, the electrochromic material can be, for example, a redox-active material, i.e. in particular a redox-active compound, or comprise at least one such material which undergoes a change in its transmission during a redox process, such as a transition from an oxidized to a reduced state (and vice versa). A corresponding redox-active material can be or comprise a metal complex compound, e.g. based on tungsten oxide (WO3), nickel oxide (NiO), molybdenum oxide (MoO3) or titanium oxide (TiO2), which undergoes a change in its transmission during a redox process, such as a transition from the oxidized to the reduced state (and vice versa). Alternatively or additionally, conjugated polymer molecules, such as PEDOT, amine derivatives, such as triphenylamine derivatives, polyimides, metallo-supramolecular polyelectrolytes ((FE-) MEPE) can be considered as electrochromic materials. A change in the transmission of the electrochromic material can be accompanied by a change in the color and/or the reflection or mirroring properties for light of certain properties of the electrochromic material and thus of the electrochromic element.

It is evident that the surface of the substrate element body 14, on which the electrochromic element is arranged or formed, is provided in the region of the outer or lateral edge in the embodiment examples according to FIGS. 10, 11 at least in sections, in particular completely, with a circumferentially inclined or curved section 14.1.2. The surface 14.1 of the substrate element body 14, on which the electrochromic element is arranged or formed, thus has a first section 14.1.1 (first surface section) and a second section 14.1.2 (second surface section). The first section 14.1.1 forms the base section of the substrate element body 14. The second section 14.1.2 forms an outer edge section of the substrate element body 14 surrounding the base section and is curved or inclined, in particular in comparison to the base section. In the form of the second section 14.1.2, the substrate element body 14 thus has an edge section that is concave or convex, curved or inclined, for example. In contrast, the first section 14.1.1 in the embodiment example according to FIGS. 10, 11 is planar; the first section 14.1.1 thus forms the aforementioned planar surface or the planar surface section of the substrate element body 14.

In the embodiments shown in FIGS. 10, 11, the substrate element body 14 thus has two different cross-sectional configurations when viewed cross-sectionally, namely a first cross-sectional configuration formed by the first section 14.1.1, i.e. the base section, and a second cross-sectional configuration formed by the second section 14.1.2, i.e. the curved or inclined edge section.

The second section 14.1.2 typically has reduced dimensions, i.e. in particular a reduced height, compared to the first section 14.1.2, whereby a particularly space-saving electrical contacting option of the electrochromic arrangement 1 is provided, since an electrical contact element formed by a contact layer 3 can be arranged or formed on the second section 14.1.2, i.e. in particular on a surface of the second section 14.1.2, can be arranged or formed without having to change the dimensions, i.e. in particular the height, of the electrochromic arrangement 1. The dimensions, i.e. in particular the height, of the electrochromic arrangement 1—this applies in particular to embodiments with circular disk-like or circular disk-shaped substrate element bodies 14, but in principle also to all other embodiments—can therefore be (essentially) determined by the dimensions, i.e. in particular the height, of the substrate element body or bodies 14 of the electrochromic arrangement 1.

As shown, the electrochromic element 5 is arranged or formed at least on the first section 14.1.1 of the surface 14.1 of the substrate element body 14; however, it is conceivable that the electrochromic element is also arranged or formed on the second section 14.1.2 of the surface 14.1 of the substrate element body 14; the electrochromic element can thus extend (only) at least in sections, possibly completely, over the first section 14.1.1 of the surface 14.1 of the substrate element body 14 or extend both at least in sections, if necessary completely, over the first section 14.1.1 and at least in sections, if necessary completely, over the second section 14.1.2 of the surface 14.1 of the substrate element body 14.

In the embodiments, the electrochromic element is exemplarily arranged or formed on an electrically conductive layer 4 or coating; consequently, the first section 14.1.1 of the surface 14.1 of the substrate element body 14 can be provided at least in sections, in particular completely, with an electrically conductive layer 4 or coating on which the electrochromic element is arranged or formed. Similarly, the second section 14.1.2 of the surface 14.1 of the substrate element body 14 can be provided at least in sections, possibly completely, with the electrically conductive layer 4 or coating, on which the electrochromic element can be arranged or formed. A corresponding electrically conductive layer 4 or coating can, for example, be a coating which is formed from a transparent conductive oxide or comprises at least one such oxide; the transparent conductive oxide can, for example, be indium tin oxide (ITO). The layer thickness of the electrically conductive layer 4 or coating can be similar or identical to the layer thickness of the layer or coating of the electrochromic material mentioned below.

Since the second section 14.1.1 of the surface 14.1 of the substrate element body 14 is typically provided with the electrically conductive layer 4 or coating over its entire surface, a very uniform electrical contacting of the electrochromic element can take place, which in turn leads to a very uniform change in the optical properties during its operation. The described arrangement or design of the electrically conductive layer 4 or coating therefore enables a change in brightness or contrast largely circumferentially from “outside to inside” and excludes any undesirable phenomena, such as discoloration in the manner of a stage curtain.

The electrochromic element can also be a layer or coating or comprise at least one such layer or coating. The layer or coating can be formed from the electrochromic material or comprise at least one such material. The thickness of the layer or coating may, for example, be in a range between 10 nm and 1000 nm, in particular in a range between 10 nm and 850 nm, further in particular between 10 and 750 nm, further in particular between 10 and 650 nm, further in particular between 10 and 550 nm, further in particular in a range between 10 nm and 500 nm, further in particular in a range between 10 nm and 250 nm. In a specific embodiment example, the electrochromic element 5 can consist of a layer or coating of tungsten or tungsten oxide or based on tungsten or tungsten oxide. The layer thickness is then preferably in a range between 100 nm and 750 and 850 nm, in particular around 800 nm.

In the embodiment example shown in FIG. 10, the second section 14.1.2 is inclined. The second section 14.1.2 thus forms an inclined surface. The second section 14.1.2 or the inclined surface can, for example, run at an angle α from a range of 91-179°, in particular 115-145°, further in particular 125-135°, with respect to the first section 14.1.1, in particular the exposed surface of the first section 14.1.1. Thus, by selecting a corresponding angle α or angle range, there is basically a design parameter for realizing a desired electrical contacting of the electrochromic arrangement 1; in particular, the angle α or angle range can be selected with regard to the geometric-constructive configuration of the electrical contact element in order to realize the largest possible electrical contacting of the electrically conductive coating 4.

In the embodiment example according to FIG. 11, the second section 14.1.2 is curved. The second section 14.1.2 thus forms a convex or concave curved surface. The second section 14.1.2 or the curved surface can, for example, have a radius from a range of 15-45°, in particular 20-40°, further in particular 25-35°. As indicated schematically in FIG. 11, the curved second section 14.2.2 can lie on a circular radius r from a range between 0.5 mm and 30 mm. The circular radius r can refer to an imaginary circle (cf. the dotted line K), the center Z of which lies on an imaginary line extending axially through the center of the substrate element body 14. Consequently, the selection of a corresponding radius r or radius range also basically provides a constructive parameter for realizing a desired electrical contacting of the electrochromic arrangement 1; in particular, the radius r or radius range can be selected with regard to the geometric-constructive configuration of an electrical contact element in order to realize an electrical contacting of the electrically conductive coating 4 that is as planar as possible.

The same applies to the embodiment example according to FIG. 12, in which the overall curved upper side of the substrate element body 14 can lie on a corresponding circular radius.

A further design parameter that is significant for the realization of a desired electrical contacting of the electrochromic arrangement 1 can be the length L or the radial extension (for rotationally symmetrical surfaces, for example in the case of the circular disk-like or circular disk-shaped design of the substrate element body 14 shown in FIGS. 10, 11) of the second section 14.1.2; the length L of the second section 14.1.2 can generally be at least 1 mm. The radial dimensions of the second section 14.1.2 can be at least 1% of the (maximum) diameter D of the substrate element body 14; as mentioned, this applies in particular to rotationally symmetrical substrate element bodies 14, i.e., for example, to the circular disk-like or circular disk-shaped substrate element bodies 14 shown in FIGS. 10, 11.

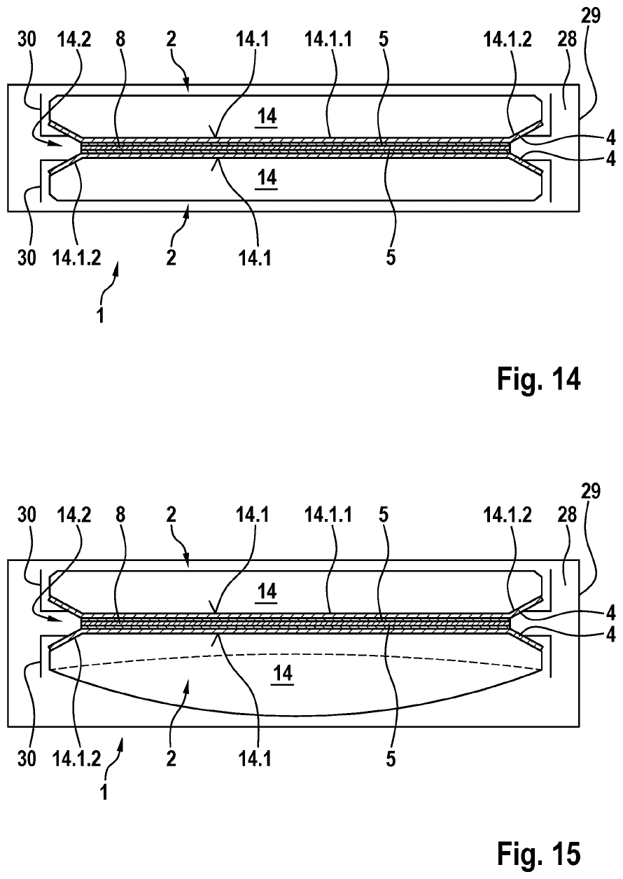

The embodiment example according to FIG. 14 shows a variant of the electrochromic arrangement 1 with several substrate element bodies 14, which can be configured, for example, according to any one of the embodiment examples according to FIG. 10 or FIG. 11, and thus several electrochromic elements. The substrate element bodies 14 can be configured identically, as FIG. 14 indicates by way of example.

The substrate elements 2 or the substrate element bodies 14 and thus the respective electrochromic elements 5 are arranged stacked on top of each other in the embodiment example shown in FIG. 14. A layer 6 or coating of an electrolyte material, in particular a liquid or gel electrolyte material, e.g. based on a metal salt, is arranged or formed between the electrochromic elements. The layer thickness of the at least one layer 6 or coating of the electrolyte material can, for example, be in a range between 100 and 500 μm.

It is evident that the substrate elements 2 or the substrate element bodies 14 are arranged on top of each other in a stack-like or -shaped manner, so that their respective second sections 14.1.2 face each other, forming a wedge-like or -shaped intermediate space 14.2 when viewed cross-sectionally. The intermediate space 14.2 also forms a space volume for compact electrical contacting of the respective substrate elements 2 or the associated electrochromic elements with an electrical contact element 30. However, the contact layers of the respective substrate elements 2 or substrate element bodies 14 do not contact each other in order to avoid short circuits. As mentioned, an electrolyte layer, in particular a liquid or gel electrolyte layer, made of an electrolyte material, e.g. based on a metal salt, can be arranged or formed between the respective electrochromic elements.

In FIG. 14, it is also indicated purely schematically that the substrate elements 2 or the substrate element bodies 14 can be embedded in or surrounded by an insulating material 28, in particular an electrically and/or thermally insulating casting compound, for example based on a plastic or plastic resin, at least in sections. In this way, the electrochromic elements, but also corresponding contact layers, can be protected from external influences, e.g. electrical, climatic, mechanical, thermal influences.

It should be noted that the entire electrochromic arrangement 1 according to the embodiment example according to FIG. 14 (the same applies to all other embodiment examples) can also be arranged in a schematically indicated receiving or housing part 29. In particular, the substrate elements 2 or the substrate element bodies 14 can be arranged in a receiving space of a corresponding receiving or housing part 29 and embedded in this receiving space, for example by casting, in a corresponding insulating material 28. A corresponding receiving or housing part thus typically not only provides additional protection against corresponding external influences, but can also improve the handling of the electrochromic arrangement 1, for example in the context of mounting in a long-range optical device 9.

Based on the embodiment example according to FIG. 15, it can be seen that at least one substrate element 2 can have a substrate element body 14 with an optically effective outer surface—in the embodiment example, this outer surface is exemplarily the underside of the lower substrate element 2.

In the embodiment example, it is shown by way of example for the lower substrate element 2, which is provided with the electrochromic element on its outer surface forming its upper side of the substrate element body 14, that the surface of the substrate element body 14 opposite this outer surface, i.e. in the embodiment example the outer surface forming the underside of the substrate element body 14, can be formed with a convex or concave curvature, i.e. generally with an optically effective shaping. Conversely, if the electrochromic element is arranged or formed on an outer surface forming the lower surface of the substrate element body 14, the surface of the substrate element body 14 opposite this outer surface, i.e. the outer surface forming the upper surface of the substrate element body 14, may be formed with a convex or concave curvature, i.e. generally with an optically effective shaping. The same can apply to any other substrate element 2 of the electrochromic arrangement 1.

Another conceivable curvature of the corresponding outer surface of the lower substrate element 2 is indicated by a dashed line in FIG. 15 purely as an example.

For the sake of completeness, although not shown, it should be mentioned that a corresponding stack-like or stack-shaped arrangement of respective substrate element bodies 14 on top of each other is also conceivable if the mutually facing outer surfaces of the substrate element bodies 14 do not have flat sections, but are, for example, curved. In this case, the curvatures of the substrate element bodies 14 are typically of corresponding or opposing design, which enables a stack-like or stack-shaped arrangement of respective substrate element bodies 14 one above the other.

It can be seen from the figures that the electrochromic arrangement 1 comprises at least one electrical contact element, cf. the contact layer 3, for electrically contacting a respective electrochromic element, cf. the layer 5, with an electrical energy source or supply. Specifically, a respective electrical contact element—this can be or comprise, for example, a wire 30, a cable, a contact ring, a stranded wire, etc.—can be contacted with a corresponding electrically conductive layer 3 or coating, which can also be referred to as an electrical contact layer. The electrical contact element can electrically contact an exposed section of the electrically conductive layer or coating, which is arranged or formed in particular in the region of the second section 14.1.2 of the surface 14.1 of the respective substrate element body 14.

For all embodiments, the second portion 14.1.2 of the surface 14.1 of the substrate element body 14 may have a different roughness than the first portion 14.1.1 of the surface 14.1 of the substrate element body 14. In particular, the second section 14.1.2 may have a lower roughness than the first section 14.1.1 of the surface 4.1 of the substrate element body 14. In this way, a very constant application of the electrically conductive layer 7 or coating can be ensured, for example with regard to the layer thickness, which in turn can bring advantages in connection with the electrical contacting of the electrochromic element. Specifically, the second section 14.1.2 can have a surface specification of P1, P2, P3 or P4 in accordance with DIN ISO 10110-8. In particular, a surface specification of P2, P3 or P4, especially P3 or P4, in accordance with DIN ISO 10110-8 may be considered. The surface specification of the first section 14.1.1 is correspondingly lower; for example, the surface specification of the first section 14.1.1 can be P3 according to DIN ISO 10110-8 and the surface specification of the second section 14.1.2 can be P2 according to DIN ISO 10110-8.

For all embodiments, the electrochromic arrangement 1 can also have at least one spacer element (not shown) made of an electrically insulating material, such as a plastic, which is arranged or formed on the electrochromic element at least in sections, if necessary completely. The at least one spacer element can have a ring-like or ring-shaped basic shape. The outer dimensions of the at least one spacer element having a corresponding ring-like or ring-shaped basic shape can correspond to the outer dimensions of the respective substrate element body 14, so that the at least one spacer element rests flush on the substrate element body 14. The aforementioned layer or coating of an electrolyte material can be arranged or formed within the inner space defined by the ring-like or ring-shaped basic shape of the at least one spacer element. The at least one spacer element is configured in particular to distance or separate the contact layers of the respective substrate elements 2 from each other so that they cannot make electrical contact.

Finally, a method for manufacturing an electrochromic arrangement 1 for a long-range optical device 9, as shown as an example in FIGS. 10-15, is explained:

The method comprises at least the steps, which may be carried out more than once: a) providing at least one substrate element 2 with a substrate element body 14, wherein the substrate element body 14 has a surface 14.1 with a first section 14.1.1 and optionally a curved or inclined second section 14.1.2; and b) applying at least one electrochromic element formed by or comprising an electrochromic material at least on the first section 14.1.1 of the surface 14.1 of the substrate element body 14.

In particular, the method comprises at least the following steps, which may be performed more than once: Providing at least one substrate element 2 with a substrate element body 14, the substrate element body 14 having a surface 14.1 with a first section 14.1.1 and optionally a curved or inclined second section 14.1.2; applying an electrically conductive layer 7 or coating to the first and second sections 14.1.1, 14.1.2 of the surface 14.1 of the substrate element body 14; applying at least one electrochromic element formed by or comprising an electrochromic material at least on the electrically conductive layer 4 or coating at least in the region of the first section 14.1.1 of the surface 14.1 of the substrate element body 14. The electrically conductive layer 4 or coating is typically applied before the electrochromic element on the respective surfaces or sections 14.1.1, 14.1.2 of the substrate element body 14.

Within the framework of the method, it is possible to arrange configured substrate elements 2, as described above, lying one above the other, in particular in such a way that respective second sections 14.1.2 of the surface 14.1 of the respective substrate element bodies 14 are arranged opposite one another, forming a wedge-like or wedge-shaped intermediate space 14.2.

The method may further comprise a step of electrically contacting respective electrically conductive layers 4 or coatings and thus respective second sections 14.1.2 with an electrical energy source or supply. For this purpose, the respective second sections can each be contacted with the electrical energy source or supply via at least one electrical contact element, such as a wire, a cable, a contact ring, a stranded wire, etc.

Individual, several or all features described in connection with one embodiment example can be combined with individual, several or all features described in connection with at least one other embodiment example.

1. A long-range optical device, comprising at least one display region for displaying optical information, wherein:
at least two electrochromic arrangements associated with the at least one display region, which can each be transferred into one or more operating states in order to change the brightness and/or the colorfulness and/or the contrast of respective optical information, and
a control device associated with the at least two electrochromic arrangements, which is configured to generate control information for transferring the at least two electrochromic arrangements into one or more respective operating states.

2. The long-range optical device according to claim 1, wherein the at least two electrochromic arrangements can be transferred into one or more respective operating states depending on or independently of one another.

3. The long-range optical device according to claim 1, wherein the at least two electrochromic arrangements are arranged or formed in an optical channel of the long-range optical device.

4. The long-range optical device according to claim 3, wherein a first electrochromic arrangement is associated with an objective lens, and a second electrochromic arrangement (1) is associated with an eyepiece of the optical channel.

5. The long-range optical device according to claim 1, wherein at least a first electrochromic arrangement is arranged or formed in a first optical channel of the long-range optical device and at least a second electrochromic arrangement is arranged or formed in a second optical channel of the long-range optical device.

6. The long-range optical device according to claim 1, wherein a first electrochromic arrangement is associated with an optical channel of the long-range optical device for adjusting the brightness and/or the colorfulness and/or the contrast of the optical information viewable via the optical channel, and a second electrochromic arrangement is associated with an electronic display device of the long-range optical device for adjusting the brightness and/or the colorfulness and/or the contrast of the optical information generated via the electronic display device.

7. The long-range optical device according to claim 6, wherein the optical information generated by the electronic display device can be coupled-in via an optical coupling device.

8. The long-range optical device according to claim 1, wherein a first electrochromic arrangement is configured in respective one or more operating states for adjusting a defined brightness and/or a defined contrast of respective optical information in a first brightness and/or contrast range, and a second electrochromic arrangement is configured in respective one or more operating states for adjusting a defined brightness and/or a defined contrast of respective optical information in a second brightness and/or contrast range.

9. The long-range optical device according to claim 8, wherein the second brightness and/or contrast range is equal to or different from the first brightness and/or contrast range.

10. The long-range optical device according to claim 1, wherein a first electrochromic arrangement is configured in respective one or more operating states for adjusting a defined chromaticity of respective optical information in a first wavelength range, and a second electrochromic arrangement is configured in respective one or more operating states for adjusting a defined chromaticity of respective optical information in a second wavelength range.

11. The long-range optical device according to claim 10, wherein the second chromaticity range is equal to or different from the first chromaticity range.

12. The long-range optical device according to claim 11, wherein the second chromaticity range is unequal to the first chromaticity range, wherein the second chromaticity range is a complementary chromaticity range to the first chromaticity range.

13. The long-range optical device according to claim 1, further comprising a control device which is configured to implement a blocking functionality of the long-range optical device by transferring the at least two electrochromic arrangements into respective operating states.

14. The long-range optical device according to claim 1, wherein the at least two electrochromic arrangements are structurally arranged or formed together in a modular or modular-shaped assembly.

15. The long-range optical device according to claim 1, wherein the at least two electrochromic arrangements each comprise at least one electrochromic element formed by or comprising an electrochromic material arranged or formed between two electrically conductive elements arranged or formed on a substrate element in each case, wherein;
two electrically conductive elements are at least arranged or formed on at least one substrate element, wherein a first electrically conductive element arranged or formed on a first surface of the at least one substrate element is associated with a first electrochromic arrangement, and a second electrically conductive element arranged or formed on a second surface of the at least one substrate element is associated with a second electrochromic arrangement.
